(19) United States
(12) Patent Application Publication
(10) Pub. No.: US 2025/0069855 A1
(43) Pub. Date: Feb. 27, 2025

(54) PACKAGING CONTAINER, PLASMA PROCESSING APPARATUS AND PROCESSING METHOD

(71) Applicant: PLASMAPP CO., LTD., Daejeon (KR)

(72) Inventors: You Bong LIM, Daejeon (KR); Jun Young KIM, Daejeon (KR); Ho Su KIM, Daejeon (KR)

(73) Assignee: PLASMAPP CO., LTD., Daejeon (KR)

(21) Appl. No.: 18/723,233

(22) PCT Filed: Dec. 26, 2022
(86) PCT No.: PCT/KR2022/021330

§ 371 Date: Jul. 1, 2024

(30) Foreign Application Priority Data
Dec. 24, 2021 (KR) 10-2021-0186977
Jan. 28, 2022 (KR) 10-2022-0013567
May 25, 2022 (KR) 10-2022-0064367
Jul. 27, 2022 (KR) 10-2022-0093528
Oct. 12, 2022 (KR) 10-2022-0130915

(51) Int. Cl. H01J 37/32; A61C 13/08; A61C 19/02

(52) U.S. Cl. CPC H01J 37/32348; A61C 19/02; A61C 13/08

(57) ABSTRACT

An embodiment of the present disclosure provides a packaging container, a plasma treatment apparatus including the same, and a plasma treatment method, wherein the packaging container includes a housing portion capable of accommodating a treatment target, wherein the housing portion includes a permeable portion which is permeable to gas, and an electrical connection member electrically connectable to an electrode portion disposed externally, and dielectric-barrier discharge is generated inside the housing portion through the permeable portion so that the treatment target accommodated inside the housing portion is plasma-treated.

### TECHNICAL FIELD

The present disclosure relates to a packaging container, a plasma treatment apparatus, and a plasma treatment method, and more specifically, to a packaging container in which plasma is generated therein, a plasma treatment apparatus, and a plasma treatment method.

### BACKGROUND ART

In general, plasma treatment is used for various purposes in various industries such as semiconductor, display, agricultural, and medical industries.

In particular, plasma surface treatment is being used on biomaterials for human skin restoration (skin graft), which are used for replacing, restoring, and reconstructing human tissues and organs, such as skin (dermal or cutaneous tissue) in the medical industry. Plasma surface treatment has an effect of improving biocompatibility and transplantation characteristics.

One of surface modifications through plasma treatment is to modify a surface of a treatment target from hydrophobicity to hydrophilicity. Such a hydrophilic surface modification is widely used in medical fields related to artificial bodies such as implants.

Plasma surface treatment technologies have developed from the perspective of a structure and process operation for plasma discharge concentrated on a surface of a treatment target. In accordance with the purpose of surface treatment of such objects, technologies for preventing filament discharge and performing glow discharge have been developed.

Conventional technologies for glow discharge or plasma discharge for object surface treatment have had limitations in that the technologies are effective only for objects with a specific shape and size, and have had a problem that uniform discharge is not achieved throughout the entire inside of a container in which an object, which is a treatment target, is accommodated.

In addition, since a treatment target is component that is inserted into the tissues of the human body, a sterile state and surface activation state should be maintained, and thus, most of all, preventing contamination or damage during packaging, transportation, and opening of a package is becoming a major problem. In the case of certain ampoules that store objects to be treated such as implant fixtures, since the fixture is implanted directly into the alveolar bone, when the fixture is stored in the ampoule, there is a need for a component for maintaining sterility and preventing contamination and damage of the fixture.

### DETAILED DESCRIPTION OF THE DISCLOSURE

### Technical Problem

The technical problem to be achieved by the present disclosure is to providing a packaging container, a plasma treatment apparatus, and a plasma treatment method in which the stability of an electrical connection with an external electrode portion may be secured, and dielectric-barrier discharge may be generated in the inside in which a treatment target, thereby plasma-treating the treatment target.

### Technical Solution to Problem

According to an embodiment of the present disclosure, there is provided a packaging container including a housing portion capable of accommodating a treatment target, wherein the housing portion includes a permeable portion through which gas is permeable, and an electrical connection member electrically connectable to an electrode portion disposed externally, and dielectric-barrier discharge is generated inside the housing portion through the permeable portion so that the treatment target accommodated inside the housing portion is plasma-treated.

According to an embodiment of the present disclosure, there is provided a plasma treatment apparatus including an accommodation portion in which a packaging container, in which a treatment target is accommodated and at least one hole is formed, is accommodated; and an electrode portion which is disposed on one surface of the accommodation portion facing the hole, and generates an electric field inside the packaging container through the hole.

According to an embodiment of the present disclosure, there is provided a plasma treatment method including accommodating a packaging container in an accommodation portion of a plasma treatment apparatus, wherein the packaging container has a permeable portion which is arranged to face an electrode portion provided in the plasma treatment apparatus and has at least one hole, and a treatment target is accommodated in the packing container, and generating an electric field inside the accommodation portion, wherein the electric field is generated inside the packaging container through the hole.

### Advantageous Effects of the Disclosure

In a packaging container according to embodiments of the present disclosure, a flow path of plasma may be formed through a hole formed in a permeable portion provided in the packaging container, and plasma treatment efficiency for a treatment target accommodated inside the packaging container may be improved.

In addition, since a permeable portion, which is provided in a packaging container and in which at least one hole is formed, is disposed to face an electrode portion, there is an effect of concentrating an electric field due to the generation of an electric field and the flow of plasma.

### BRIEF DESCRIPTION OF DRAWINGS

FIG. 1 is a schematic view illustrating a plasma treatment apparatus according to an embodiment of the present disclosure.

Referring to FIGS. 2 to 8, FIGS. 2 to 8 are conceptual views illustrating a packaging container according to embodiments of the present disclosure.

FIG. 9 is a conceptual view illustrating an electrode portion according to another embodiment of the present disclosure.

FIG. 10 is a conceptual view illustrating a connection jig according to an embodiment of the present disclosure.

Referring to FIGS. 11A to 11C, FIGS. 11A to 11C are schematic views illustrating a process by which a treatment target is plasma-treated by a plasma treatment apparatus according to an embodiment of the present disclosure.

Referring to FIG. 12A, FIG. 12A is a schematic view illustrating a plasma treatment apparatus according to another embodiment of the present disclosure.

Referring to FIGS. 12B and 12C, FIGS. 12B and 12C are schematic views illustrating a process by which a treatment target is plasma-treated by a plasma treatment apparatus according to another embodiment of the present disclosure.

FIG. 13 is a flowchart illustrating a plasma treatment method of a treatment target by using a plasma treatment apparatus according to embodiments of the present disclosure.

FIG. 14 is a perspective view illustrating a packaging container according to another embodiment of the present disclosure.

FIG. 15 is a cross-sectional view taken along line I-I of FIG. 14.

FIG. 16 is a plan view of FIG. 14.

FIG. 17 is a perspective view illustrating a plasma treatment apparatus according to a third embodiment of the present disclosure.

FIG. 18 is a perspective view illustrating a packaging container according to another embodiment.

FIG. 19 is a perspective view illustrating that an opening/closing portion of a plasma treatment apparatus according to another embodiment of the present disclosure is opened.

FIG. 20 is a conceptual view illustrating a packaging container according to another embodiment of the present disclosure.

FIG. 21 is a perspective view illustrating the inside of a plasma treatment apparatus according to another embodiment of the present disclosure.

FIG. 22 is a view illustrating an embodiment in which a packaging container is accommodated in a plasma treatment apparatus according to another embodiment of the present disclosure by using a connection jig for a plasma treatment apparatus.

FIG. 23 is a perspective view illustrating a connection jig for a plasma treatment apparatus according to another embodiment of the present disclosure.

FIG. 24 is a cross-sectional view taken along line II-II of FIG. 23.

FIG. 25 is a view for describing an operation in a state in which a packaging container and a connection jig are applied to a plasma treatment apparatus according to another embodiment of the present disclosure.

### BEST MODE

According to an embodiment of the present disclosure, there is provided a packaging container including a housing portion capable of accommodating a treatment target, wherein the housing portion includes a permeable portion through which gas is permeable, and an electrical connection member electrically connectable to an electrode portion disposed externally, and dielectric-barrier discharge is generated inside the housing portion through the permeable portion so that the treatment target accommodated inside the housing portion is plasma-treated.

In the present disclosure, the electrode portion may include a first electrode, and a second electrode disposed to be spaced apart from the first electrode, the electrical connection member may be electrically connectable to the first electrode, and an electric field may be generated inside the housing portion through the permeable portion by the electrical connection member and the second electrode disposed externally.

In the present disclosure, the second electrode, the permeable portion, and the electrical connection member may be aligned in a preset direction.

In the present disclosure, the treatment target may include a conductive area, the electrical connection member may be electrically connected to the treatment target, and the second electrode, the permeable portion, and the treatment target may be aligned in a preset direction.

In the present disclosure, internal pressure of the housing portion may be adjusted by the permeable portion, and the dielectric-barrier discharge may be generated inside the housing portion by using the electrical connection member as a dielectric so that the treatment target housed therein may be plasma-treated.

In the present disclosure, one side of the electrical connection member may be electrically connected to the electrode portion disposed externally to adjust a shape or intensity of an electric field for the dielectric-barrier discharge.

In the present disclosure, the other side of the electrical connection member, which is opposite to the one side, may be electrically connected to the treatment target.

In the present disclosure, the electrical connection member may fixe the treatment target.

In the present disclosure, the electrical connection member may have magnetism.

In the present disclosure, the packaging container may include an embedded portion which covers an outer circumferential surface of the electrical connection member and is made of an insulating material.

In the present disclosure, at least one hole having a size of 10 μm or less may be formed in the permeable portion.

In the present disclosure, the permeable portion may have a recovery structure in which a gas flow path is temporarily formed by an external device and then closed.

In the present disclosure, the housing portion may include a first housing body in which the treatment target is accommodated and a first permeable portion is formed, and a second housing body in which the first housing body is accommodated and a second permeable portion is formed, and may further include a sealing member which seals a gas flow path toward the first permeable portion and the second permeable portion.

In the present disclosure, the packaging container may further include a fixing member which has a fixing force counteracting an external force for taking out the treatment target from the packaging container and fixes the treatment target, and the fixing force may be released by an external force that separates the treatment target from the fixing member.

In the present disclosure, the fixing member may have an open one side through which the fixing force is released.

In the present disclosure, the fixing member may have an elastic restoring force for releasing the fixing force.

According to an embodiment of the present disclosure, there is provided a plasma treatment apparatus including an accommodation portion in which a packaging container, in which a treatment target is accommodated and at least one hole is formed, is accommodated; and an electrode portion which is disposed on one surface of the accommodation portion facing the hole, and generates an electric field inside the packaging container through the hole.

In the present disclosure, the plasma treatment apparatus may further include an airtightness forming portion which is in contact with the packaging container and forms a sealed area including an inside of the packaging container, and a pressure adjustment portion which forms a low-pressure atmosphere inside the sealed area.

In the present disclosure, the pressure adjustment portion may include a pressure adjustment hole formed opposite to the hole of the packaging container, and an exhaust portion which evacuates an inside of the sealed area through the pressure adjustment hole.

According to an embodiment of the present disclosure, there is provided a plasma treatment method including accommodating a packaging container in an accommodation portion of a plasma treatment apparatus, wherein the packaging container has a permeable portion which is arranged to face an electrode portion provided in the plasma treatment apparatus and has at least one hole, and a treatment target is accommodated in the packing container, and generating an electric field inside the accommodation portion, wherein the electric field is generated inside the packaging container through the hole.

In the present disclosure, in the generating of the electric field, the packaging container and the electrode portion may be electrically connected, and the electric field may be generated inside the packaging container

In the present disclosure, the packaging container may include an electrical connection member, the treatment target may include a conductive area, and in the generating of the electric field, the electrical connection member and the conductive area may be electrically connected to generate the electric field.

In the present disclosure, the plasma treatment method may further include, before the accommodating of the packaging container in the accommodation portion, opening the hole of the packaging container or deforming a size or shape of the hole.

In the present disclosure, the plasma treatment method may further include, before the accommodating of the packaging container in the accommodation portion, adjusting a position of the treatment target to approach the electrode portion or coupling the packaging container to a connection jig.

In the present disclosure, the plasma treatment method may further include evacuating an inner space of the accommodation portion to form a low-pressure atmosphere inside the packaging container through the hole, and discharging the low-pressure atmosphere by using the electric field to plasma-treat the treatment target.

In the present disclosure, the plasma treatment method may further include evacuating an inner space of the accommodation portion to form a low-pressure atmosphere, discharging the low-pressure atmosphere by using the electric field, and introducing the discharged low-pressure atmosphere into the packaging container through the hole to plasma-treat the treatment target.

### Mode of Disclosure

Hereinafter, the following embodiments will be described in detail with reference to the accompanying drawings, wherein like reference numerals refer to the same or corresponding components throughout the drawings, and a redundant description thereof will be omitted.

While the technical idea of the present disclosure may be modified in various ways and take on various alternative forms, specific embodiments thereof are shown in the drawings and described in detail below. However, it should be understood that this is not intended to limit the technical idea of the present disclosure to specific embodiments, and includes all transformations, equivalents, and substitutes included in the technical idea of the present disclosure.

In describing the technical idea of the present disclosure, when it is determined that the specific description of the known related art unnecessarily obscures the gist of the present disclosure, the detailed description thereof will be omitted. In addition, numeral figures (for example, 1, 2, and the like) used during describing the specification are just identification symbols for distinguishing one component from another component.

Further, in the specification, when it is described that one component is “connected to” or “accesses” the other component, it is understood that the one component may be directly connected to or may directly access the other component but unless explicitly described to the contrary, another component may be “connected” or “access” between the components.

In addition, terms such as “unit,” “er,” “or,” and “module disclosed in the present specification may refer to a unit that processes at least one function or operation, may be implemented by hardware or software such as a processor, a microprocessor, a microcontroller, a central processing unit (CPU), a graphics processing unit (GPU), an accelerated processing unit (APU), a digital signal processor (DSP), an application specific integrated circuit (ASIC), and a field programmable gate array (FPGA) or a combination of hardware and software, and may also be implemented in a form combined with a memory that stores data necessary for processing at least one function or operation.

It is intended to clarify that components in the present specification are merely distinguished according to primary functions of the components. That is, two or more components to be described below may be provided to be combined to one component, or one component may be provided to be divided into two or more components for each more subdivided function. In addition, each of the respective components to be described below may additionally perform some or all functions among functions which other components take charge of in addition to a primary function which each component takes charge of and some functions among the primary functions which the respective components take charge of are exclusively charged by other components to be performed, of course.

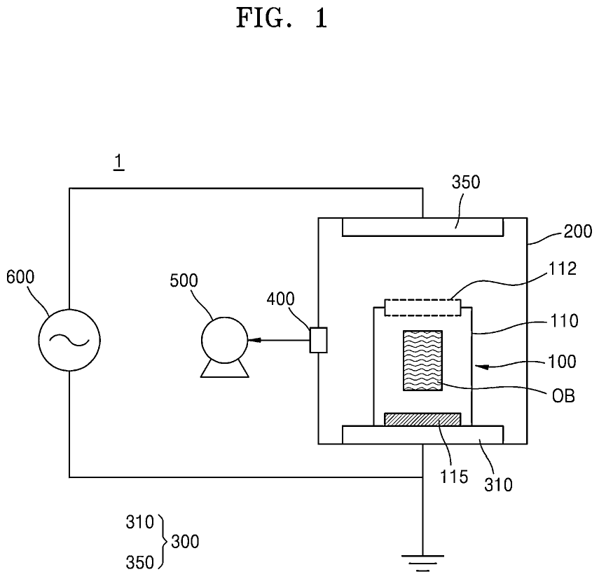

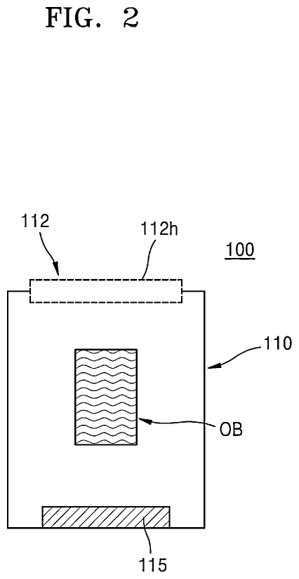

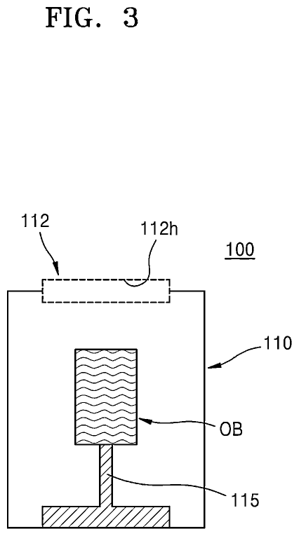

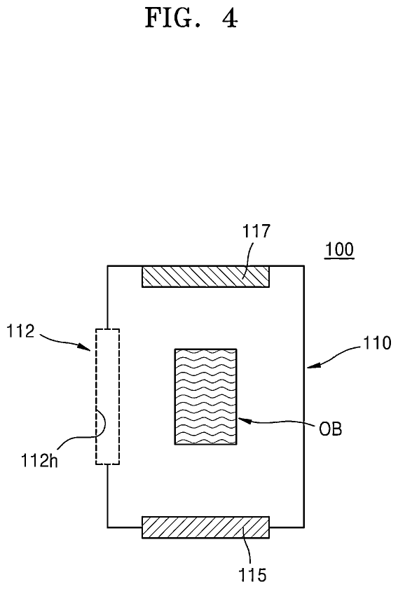

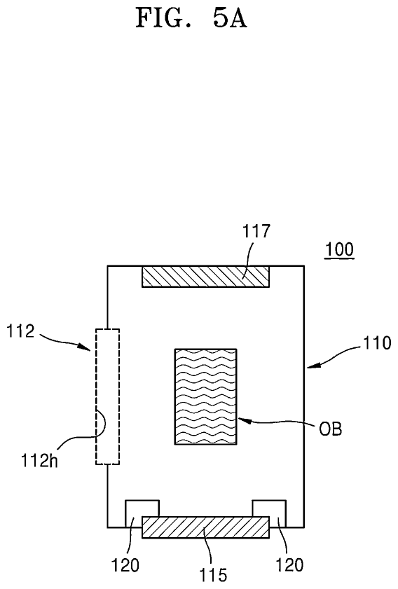

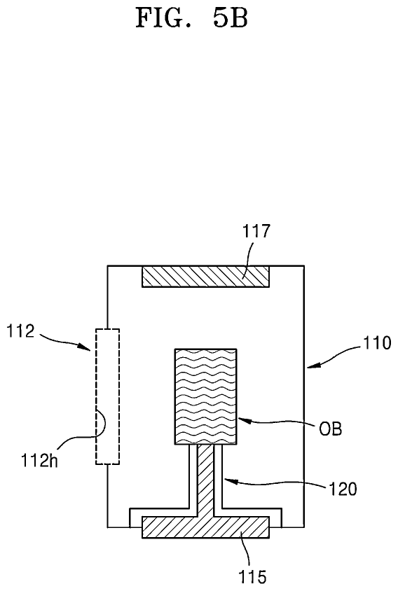

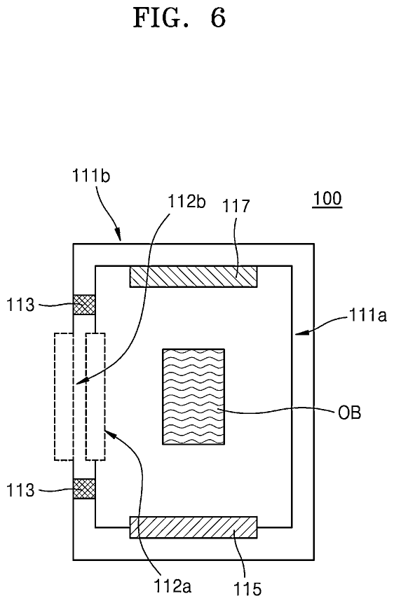

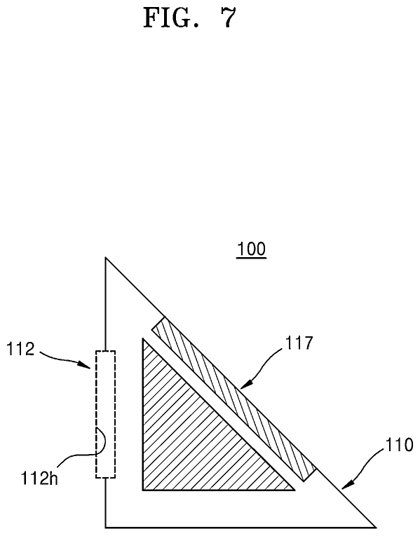

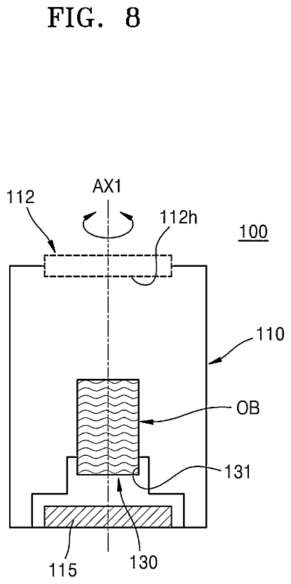

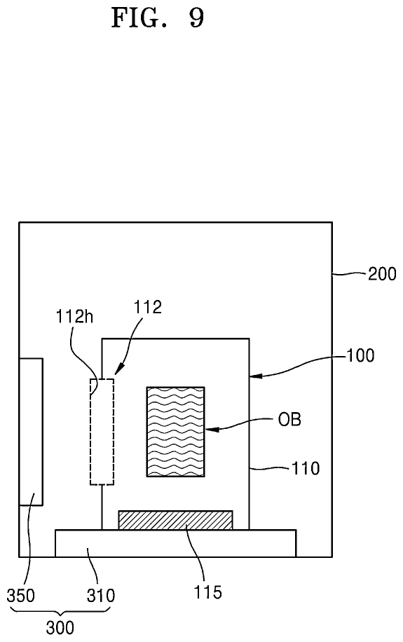

FIG. 1 is a schematic view illustrating a plasma treatment apparatus according to an embodiment of the present disclosure. Referring to FIGS. 2 to 8, FIGS. 2 to 8 are conceptual views illustrating a packaging container according to embodiments of the present disclosure. Referring to FIGS. 11A to 11C, FIGS. 11A to 11C are schematic views illustrating a process by which a treatment target is plasma-treated by the plasma treatment apparatus according to an embodiment of the present disclosure.

Referring to FIGS. 1 to 11C, a plasma treatment apparatus 1 according to an embodiment of the present disclosure may include a packaging container 100, an accommodation portion 200, an electrode portion 300, an airtightness forming portion 400, a pressure adjustment portion 500, and a power source 600.

The plasma treatment apparatus 1 according to an embodiment of the present disclosure may be used to accommodate the packaging container 100, in which a treatment target OB is accommodated, and plasma-treat the treatment target OB.

FIGS. 2 to 8 illustrating the packaging container 100 according to embodiments of the present disclosure. The packaging container 100 may accommodate the treatment target OB, may be accommodated in the plasma treatment apparatus 1, and may include a housing portion 110, an embedded portion 120, and a fixing member 130.

According to embodiments, the packaging container 100 may refer to various types of devices or containers used to perform plasma surface treatment on the treatment target OB. This will be described in detail with reference to FIGS. 2 to 8.

In the present specification, the “treatment target OB” is a target that may be sterilized through plasma treatment, that is, a crown used to cover a human tooth or the like. When a medical procedure or an implant procedure in a dental clinic is performed, the treatment target OB refers to a biomaterial for human skin restoration (skin graft), which is used for replacing, restoring, and reconstructing human tissues and organs, such as skin (dermal or cutaneous tissue) or a bone graft material that may be accommodated in an internal container such as a syringe or a vial.

As an alternative example, the treatment target OB may be an implant fixture. The implant fixture may be provided as a certain structure that is inserted into an alveolar bone to support an artificial tooth.

As an alternative embodiment, the implant fixture may vertically extend, may have a column shape as a whole, and may be made of a material such as titanium that is harmless to the human body and is easy to fuse with bone tissue, but the present disclosure is not limited thereto. Therefore, any material may be used as long as the material has similar characteristics to those described above.

As an alternative embodiment, the implant fixture may have a screw-like shape, may have a structure that increases a contact area with a periphery, and may have a configuration of which an outer diameter is expanded or reduced in a preset direction.

As an alternative example, the treatment target OB may be made of a conductive material that is conductive in itself. Accordingly, the treatment target OB may serve as an electrode for generating plasma when plasma surface treatment is performed on the treatment target OB, thereby reducing an effect of clogging a dielectric layer.

Referring to FIGS. 1 and 2, the housing portion 110 according to an embodiment of the present disclosure may form an exterior of the packaging container 100 and may have a hollow inside. The treatment target OB may be accommodated inside the housing portion 110.

Referring to FIG. 2, the housing portion 110 according to an embodiment of the present disclosure may include a permeable portion 112 and an electrical connection member 115.

Referring to FIG. 1, the permeable portion 112 according to an embodiment of the present disclosure may be disposed at one side (upper side in FIG. 2) of the housing portion 110, and at least one hole 112h may be formed therein.

Referring to FIG. 2, there is an effect that gas G may smoothly flow between the inside and the outside of the housing portion 110 through the permeable portion 112, specifically, at least one hole 112h formed therein.

Referring to FIG. 1, the permeable portion 112 formed in the housing portion 110 according to an embodiment of the present disclosure may be disposed to face an electrode portion 300 which will be described below.

The permeable portion 112 formed in the housing portion 110 according to an embodiment of the present disclosure is disposed between the electrode portions 300, specifically, between a first electrode 310 and a second electrode 350 which are disposed to face each other. In addition, plasma may flow in through the hole 112h formed in the permeable portion 112, thereby obtaining an effect of enabling plasma surface treatment of the accommodated treatment target OB.

In other words, dielectric 117-barrier discharge may be generated inside the housing portion 110 through the housing portion 110, specifically, the permeable portion 112, and thus the treatment target OB accommodated inside the housing portion 110 may be plasma-treated.

Referring to FIG. 2, the permeable portion 112 formed in the housing portion 110 according to an embodiment of the present disclosure may have at least one hole 112h. Specifically, as the hole 112h formed in the permeable portion 112, at least one hole 112h with a size of 10 μm or less may be formed.

In addition, the permeable portion 112 may be made of a material that is elastically deformable and may have a recovery structure in which a flow path of the gas G is temporarily formed by an external device and then closed.

As a result, there is an effect in which, as the pressure adjustment portion 500 to be described below is driven, the gas G such as air inside the housing portion 110 may pass through the permeable portion 112 to be exhausted to the outside of the packaging container 100, specifically, the outside of the housing portion 110, and internal pressure of the housing portion 110 may be formed in a low pressure state.

In other words, the internal pressure of the housing portion 110 may be adjusted by the permeable portion 112 according to an embodiment of the present disclosure, and the electrical connection member 115 to be described below may be used as the dielectric 117 to generate the dielectric 117-barrier discharge inside the housing portion 110, thereby obtaining an effect in which the treatment target OB accommodated therein may be plasma-treated.

Although not shown in the drawings, the permeable portion 112 may include a flow restriction portion (not shown), and the hole 112h formed in the permeable portion 112 may be covered by the flow restriction portion. The flow restriction portion allows only the flow of the gas G such as air and may block the flow of water, bacteria, foreign materials, and the like.

As a result, in order to form a low-pressure atmosphere LPA, the gas G is required to flow from the inside of the packaging container 100 to the outside, and there is an effect in which, in a process in which the gas G flows, external foreign materials may be blocked from penetrating into the packaging container 100.

Referring to FIGS. 1 to 8, the housing portion 110 according to embodiments of the present disclosure may be made of a transparent material such that the treatment target OB accommodated therein is visible. Thus, a user may visually check the treatment target OB accommodated inside the packaging container 100, specifically, the housing portion 110.

In addition, there is an effect in which a user may visually check a plasma treatment process during plasma surface treatment of the treatment target OB.

The housing portion 110 according to embodiments of the present disclosure may be made of an insulating material, for example, a resin material. Accordingly, the housing portion 110 may have a high dielectric constant value (k). As an alternative example, the dielectric constant value of the housing portion 110 may be about 10.

Referring to FIG. 7, a shape of the housing portion 110 according to an embodiment of the present disclosure may be formed to correspond to a shape of the treatment target OB accommodated inside the housing portion 110.

As a result, there is an effect in which a distance between an inner circumferential surface of the housing portion 110 and an outer circumferential surface of the treatment target OB may be formed uniformly, plasma discharge may be generated inside the treatment target OB, and uniform plasma treatment may be performed along a surface of the treatment target OB during plasma treatment.

Referring to FIG. 6, the packaging container 100 according to another embodiment of the present disclosure includes a plurality of housing bodies, specifically, a first housing body 111a, a second housing body 111b, and a sealing member 113.

Referring to FIG. 6, the first housing body 111a may accommodate the treatment target OB, and a first permeable portion 112a may be formed. The second housing body 111b may accommodate the first housing body 111a, and a second permeable portion 112b may be formed.

Referring to FIG. 6, the first housing body 111a may be disposed inside the second housing body 111b, and the first permeable portion 112a and the second permeable portion 112b may be disposed in a line in a preset direction. Since the configuration and effects of the first permeable portion 112a and the second permeable portion 112b are the same as those of the permeable portion 112 described above, redundant detailed descriptions will be omitted.

Referring to FIG. 6, the sealing member 113 may close a flow path of the gas G toward the first permeable portion 112a and the second permeable portion 112b, may be disposed between the first housing body 111a and the second housing body 111b, and may be disposed to surround the first permeable portion 112a.

Referring to FIG. 6, the sealing member 113 may be made of a material that is elastically deformable and may be formed in a ring shape.

Thus, when the gas G such as air flows from the first housing body 111a, passes through the first permeable portion 112a, and flows to the second permeable portion 112b formed in the second housing body 111b, the flow path may be sealed.

Referring to FIG. 2, the electrical connection member 115 according to an embodiment of the present disclosure may be provided in the plasma treatment apparatus 1 and may be electrically connected to the electrode portion 300 disposed outside the packaging container 100.

One side (lower side in FIG. 2) of the electrical connection member 115 may be electrically connected to the external electrode portion 300 to adjust the shape or intensity of an electric field for the dielectric 117-barrier discharge and may receive power through the electrode portion 300 such that plasma is generated in a certain space surrounding the treatment target OB.

One side (upper side in FIG. 2) of the electrical connection member 115 according to an embodiment of the present disclosure may be positioned inside the housing portion 110, and the other side (lower side in FIG. 2) opposite to the one side may be exposed to the outside of the housing portion 110.

Although not shown in the drawings, the electrical connection member may be connected to pass through the housing portion 110, and the housing portion 110 may have a hole through which the electrical connection member passes and is inserted.

The electrical connection member 115 according to an embodiment of the present disclosure may be made of a conductive material and may receive power from the outside through the exposed other side.

Referring to FIGS. 1 and 2, the electrical connection member 115 according to an embodiment of the present disclosure may be electrically connected to the electrode portion 300 disposed outside the packaging container 100, specifically, the first electrode 310, and may receive power from the power source 600 to generate an electric field inside the packaging container 100 together with the second electrode 350.

Referring to FIG. 3, the electrical connection member 115 according to another embodiment of the present disclosure may be electrically connected to the treatment target OB accommodated inside the packaging container 100 and may transmit external power to the treatment target OB.

As an alternative embodiment, the electrical connection member 115 may be made of aluminum (Al), and may have an effect of securing the stability of an electrical connection with the treatment target OB such as an implant fixture.

As an alternative embodiment, the electrical connection member 115 may be made of a magnetic material, thereby securing connectivity with the electrode portion 300 of the plasma treatment apparatus 1, which is disposed outside the packaging container 100. For example, the electrical connection member 115 may be made of a material such as iron (Fe) or nickel (Ni).

Referring to FIGS. 1, 2, 3, and 8, the electrical connection member 115 according to embodiments of the present disclosure may be aligned with the electrode portion 300, specifically, the second electrode 350, the permeable portion 112 provided in the housing portion 110, and the treatment target OB in a preset direction (vertical direction in FIG. 2).

Although not shown in the drawings, when the electrical connection member 115 and the treatment target OB are electrically connected to each other as shown in FIGS. 3 and 5B, a contact groove (not shown) having a shape of a groove may be formed in one surface (upper surface in FIG. 3) of the electrical connection member 115 in contact with the treatment target OB, and the treatment target OB may be partially inserted into the contact groove.

A shape of an inner circumferential surface of the contact groove may correspond to a shape of an outer circumferential surface of one end portion of the treatment target OB partially inserted into the contact groove. As a result, a contact area between the contact groove formed in the electrical connection member 115 and the outer circumferential surface of one end portion of the treatment target OB may be increased, which has an effect capable of securing stable connectivity.

In addition, since the treatment target OB is partially inserted into the contact groove, there is an effected in which one end portion of the treatment target OB may be supported and stably fixed to facilitate storage.

As an alternative embodiment, a contact groove may be formed in the treatment target OB, and one end portion of the treatment target OB facing the contact groove may be formed in a pointed shape to be inserted into the contact groove formed in the treatment target OB.

Referring to FIG. 4, the dielectric 117 according to an embodiment of the present disclosure may be formed in the housing portion 110 and may be formed along a preset area in the housing portion 110. The dielectric 117 may form a barrier of the dielectric 117 in the housing portion 110, and the plasma treatment apparatus 1 may generate plasma discharge inside the packaging container 100, which is a sealed area, through the dielectric 117-barrier discharge (dielectric-barrier discharge (DBD)).

Referring to FIGS. 4 to 5B, the dielectric 117 may be disposed opposite to the electrical connection member 115 with the treatment target OB interposed therebetween. The dielectric 117 and the electrical connection member 115 may be disposed between the electrode portions 300 disposed outside the packaging container 100, specifically, between the first electrode 310 and the second electrode 350, and plasma discharge may be generated inside the packaging container 100 by the electrode portion 300 receiving power from the power source 600.

Referring to FIGS. 2, 3, and 8, the dielectric 117 is not explicitly shown, but except for one area of the housing portion 110 in which the permeable portion 112 is formed, other areas may be formed as the dielectric 117.

Referring to FIG. 7, the dielectric 117 according to an embodiment of the present disclosure may be formed in a preset area of the housing portion 110 that accommodates the treatment target OB, and an area in which the dielectric 117 is formed may be formed in a shape corresponding to the shape of the treatment target OB.

As a result, there is an effect in which an electric field may be generated inside the plasma treatment apparatus 1, specifically, the packaging container 100 by the electrode portion 300 receiving power from the power source 600, and plasma treatment may be uniformly performed along the surface of the treatment target OB accommodated inside the packaging container 100.

Referring to FIGS. 5A and 5B, the embedded portion 120 according to an embodiment of the present disclosure is installed in the housing portion 110 and may partially cover an outer circumferential surface of the electrical connection member 115. The embedded portion 120 is made of an insulating material and has an effect of covering the outer circumferential surface of the electrical connection member 115 by a preset area to generate an electric field inside the packaging container 100 through the remaining area.

Referring to FIG. 5A, the embedded portion 120 may be formed in a ring shape and may cover the outer circumferential surface of the electrical connection member 115 in a circumferential direction with respect to a center of the electrical connection member 115.

Referring to FIG. 5B, the embedded portion 120 according to an embodiment of the present disclosure may surround the outer circumferential surface of the electrical connection member 115 that is electrically connected to the treatment target OB and may be installed inside the housing portion 110, to surround the remaining area except for one end portion (upper end portion in FIG. 5B) of the electrical connection member 115 that may be in contact with the treatment target OB.

Thus, there is an effect in which an electric field may be generated to be concentrated between one area of the electrical connection member 115 and the electrode portion 300 facing the one area, specifically, the second electrode 350, wherein the one area of the electrical connection member 115 is not covered by the embedded portion 120.

Referring to FIG. 8, the fixing member 130 may fix the treatment target OB accommodated inside the packaging container 100, specifically, the housing portion 110, may have a fixing force that counteracts an external force for taking out the treatment target OB from the packaging container 100, and may fix the treatment target OB.

The fixing member 130 according to an embodiment of the present disclosure may be fixedly positioned and installed inside the housing portion 110 and may be in direct contact with the treatment target OB accommodated inside the housing portion 110. The fixing member 130 may be in contact with the treatment target OB and may fix a position of the treatment target OB.

Referring to FIG. 8, one side (lower side in FIG. 8) of the fixing member 130 may cover the electrical connection member 115 inside the housing portion 110, and the other side (upper side in FIG. 8) of the fixing member 130 may be in contact with the treatment target OB accommodated inside the housing portion 110.

The fixing member 130 has an effect of stably fixing the position of the treatment target OB.

According to an embodiment of the present disclosure, a fixing groove 131 having a preset depth and a shape of a groove may be formed in one surface (upper surface in FIG. 8) of the fixing member 130 which faces the treatment target OB.

As a result, there is an effect in which the treatment target OB may be inserted into and seated in the fixing groove 131 formed in the fixing member 130, and the position of the treatment target OB disposed in the fixing groove 131 may be fixed.

A shape of an inner circumferential surface of the fixing groove 131 formed in an outer circumferential surface (upper surface in FIG. 8) of the fixing member 130 according to an embodiment of the present disclosure may be formed to correspond to a shape of the outer circumferential surface of the treatment target OB inserted into and disposed in the fixing groove 131.

The fixing force of the fixing member 130 according to an embodiment of the present disclosure may be released by an external force that separates the treatment target OB from the fixing member 130.

As an alternative embodiment, the external force that separates the treatment target OB from the fixing member 130 may be a rotational force, and the fixing force may be a rotation prevention force that counteracts rotation.

As an alternative embodiment, the fixing member 130 may include a plurality of fixing protrusions (not shown) formed to protrude in a direction toward the treatment target OB. The plurality of fixing protrusions may be fastened to an inner surface of the treatment target OB.

Thus, the fixing member 130 in which the fixing protrusion is formed may has an effect capable of stably fixing the treatment target OB and having the rotation prevention force.

As an alternative embodiment, the fixing protrusions formed in the fixing member 130 may have various sizes and shapes and may be formed to correspond to the size and shape of the treatment target OB so as to fix the treatment target OB.

As an alternative embodiment, the fixing member 130 may have open one side. The treatment target OB may be separated from the fixing member 130 by releasing a fixing force through the one side of the fixing member 130.

As an alternative embodiment, the fixing member 130 may have an elastic restoring force that releases the fixing force.

Specifically, a user may perform an action of twisting the treatment target OB to separate the treatment target OB from the fixing member 130 and may apply an external force to move the treatment target OB to the open one side of the fixing member 130 and separate the treatment target OB from the fixing member 130.

In this case, since the fixing member 130 has an elastic restoring force, the fastening between the fixing protrusion and the inner surface of the treatment target OB may be released, the fixing force may be released, and a user may separate the treatment target OB from the fixing member 130.

Referring to FIGS. 1 and 11A to 11C, the accommodation portion 200 according to an embodiment of the present disclosure may accommodate the packaging container 100 in which the treatment target OB is accommodated and at least one hole 112h is formed, and the electrode portion 300 may be installed therein.

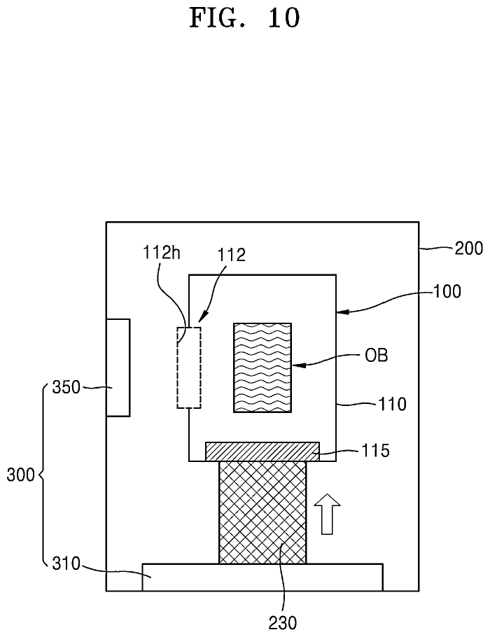

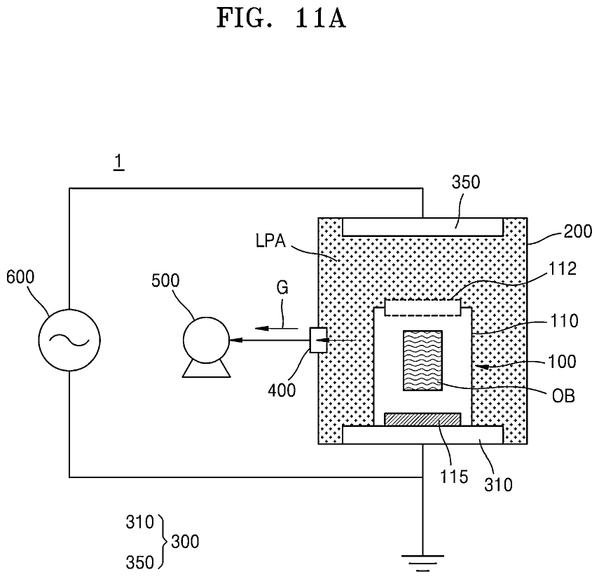

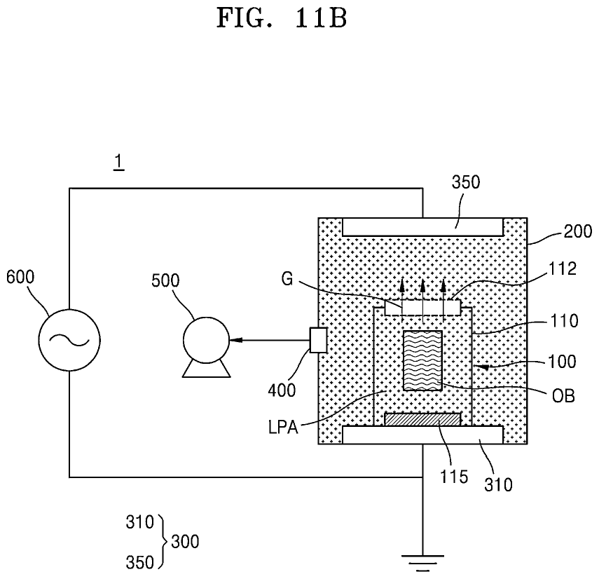

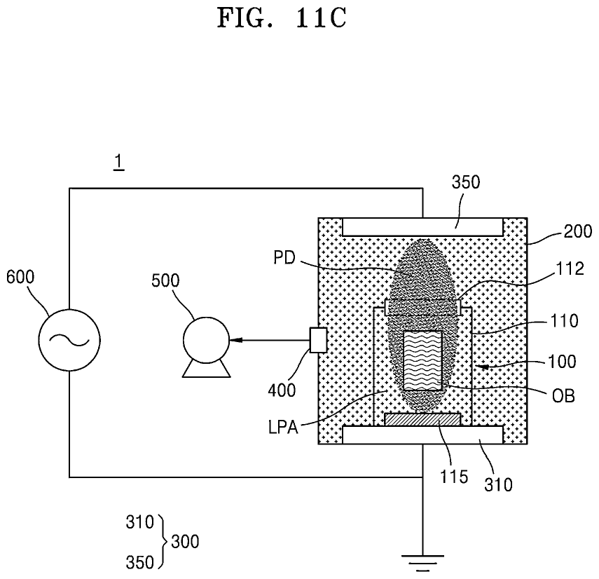

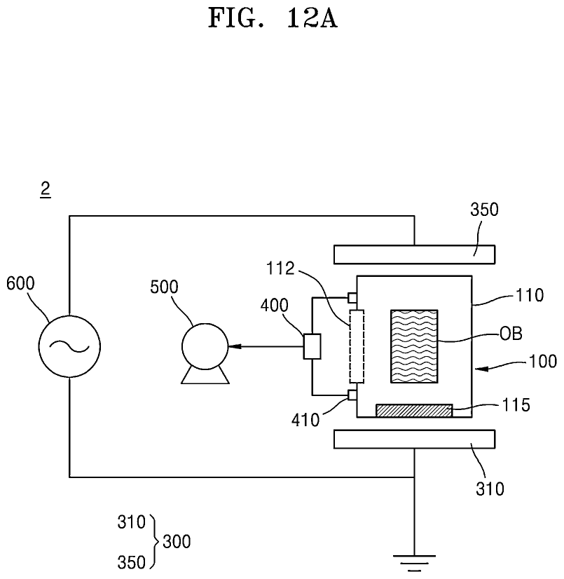

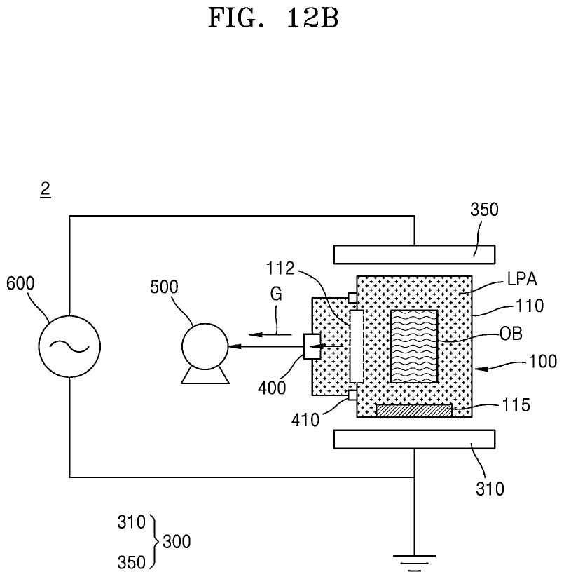

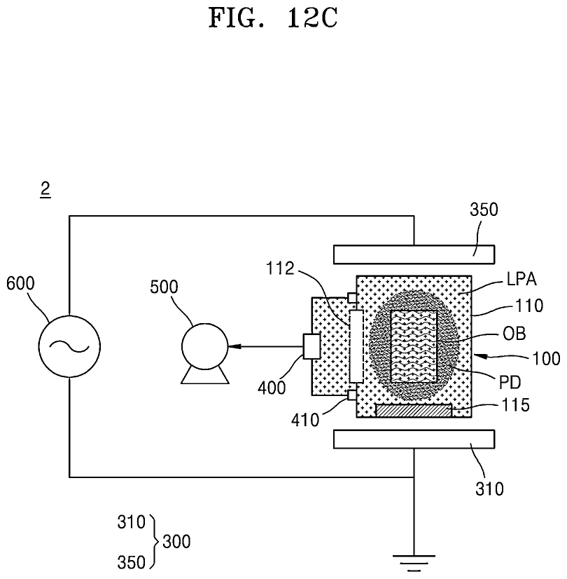

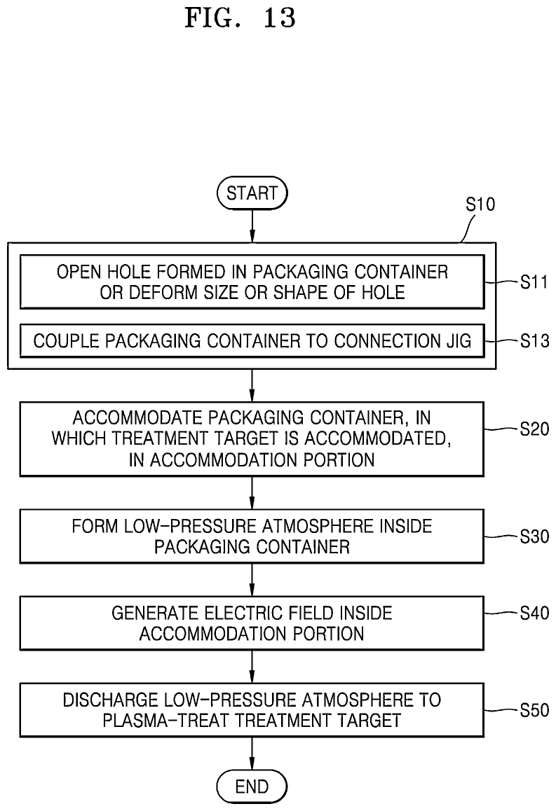

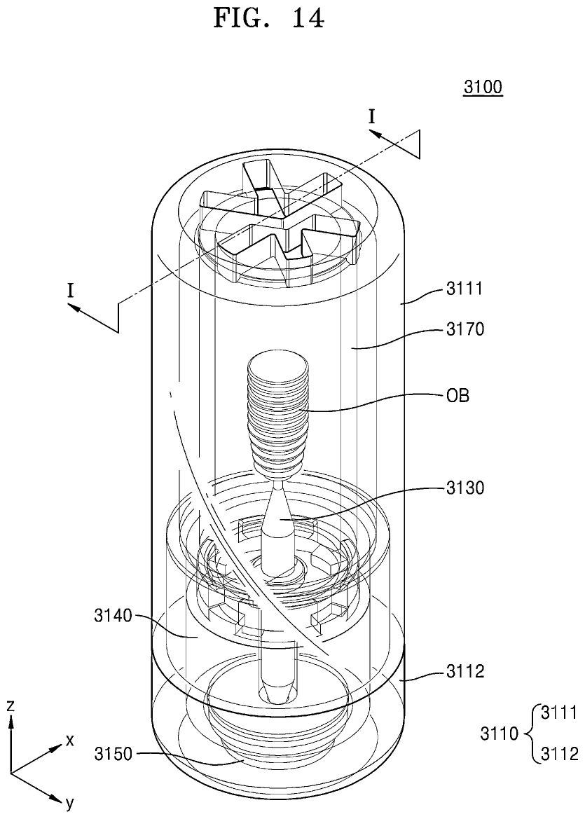

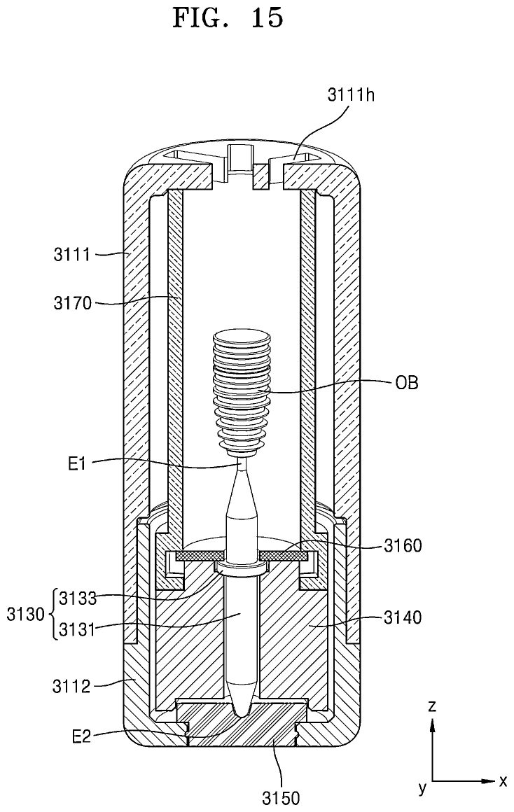

Referring to FIG. 1, the accommodation portion 200 according to an embodiment of the present disclosure may have a hollow inside, and the electrode portion 300, specifically, the first electrode 310 and the second electrode 350, may be installed therein. The first electrode 310 and the second electrode 350 may be disposed in a line to face each other as shown in FIG. 1 or may be disposed not to face each other as shown in FIG. 9.

Referring to FIG. 1, the accommodation portion 200 may be connected to the airtightness forming portion 400 to be described below, and the gas G such as air passing through the hole 112h formed in the packaging container 100 to be exhausted into the accommodation portion 200 may pass through the airtightness forming portion 400 may be exhausted to the outside as the pressure adjustment portion 500 is driven.

Referring to FIG. 1, the packaging container 100 may be seated in the accommodation portion 200, and the packaging container 100 may be disposed to be fixedly positioned inside the accommodation portion 200.

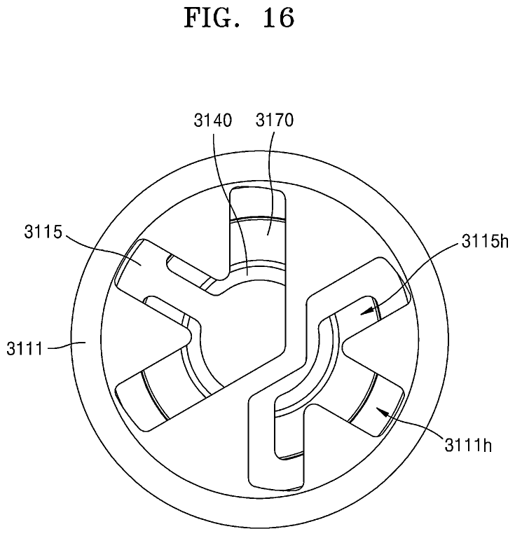

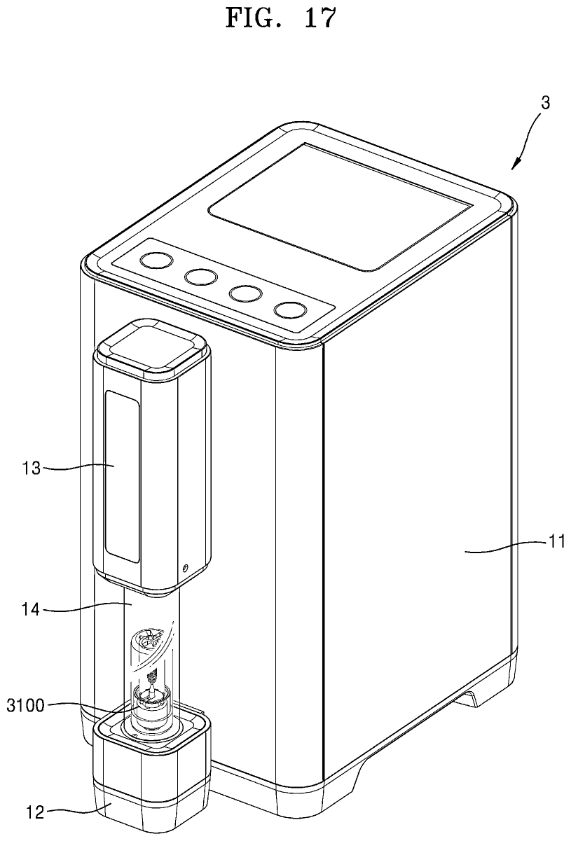

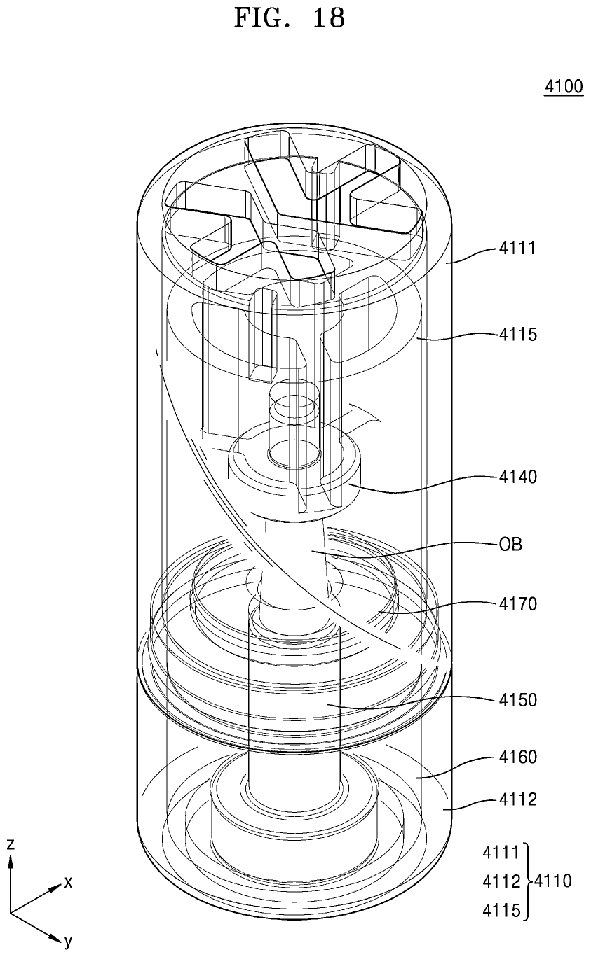

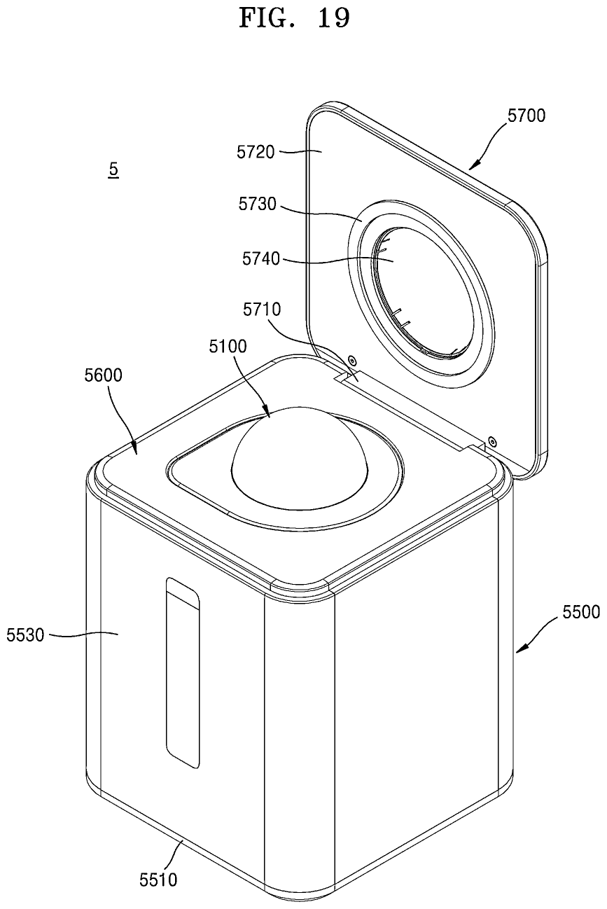

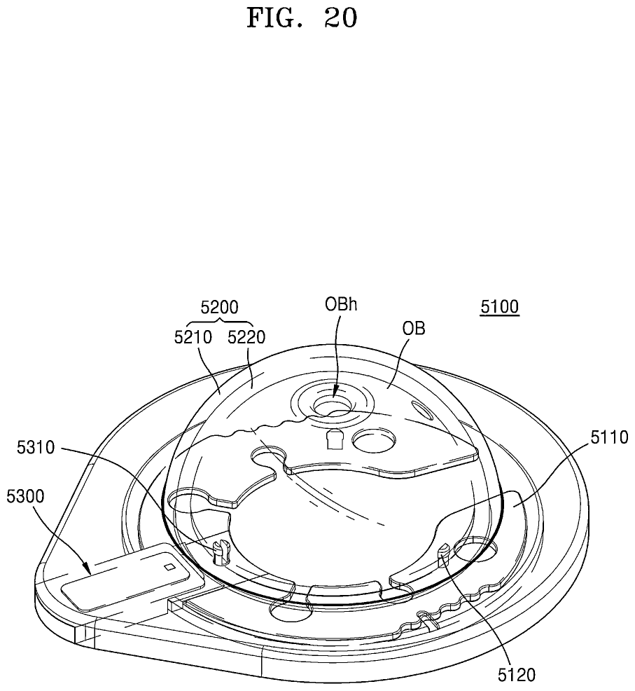

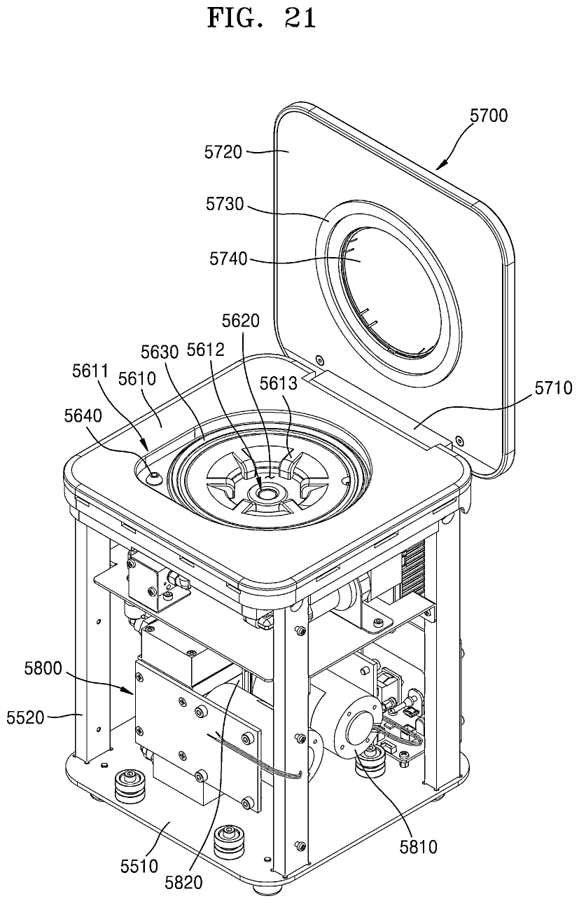

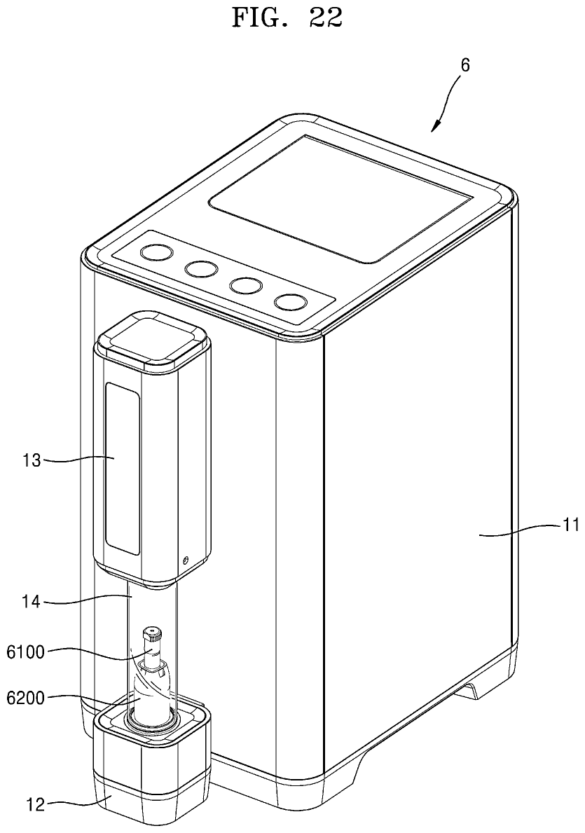

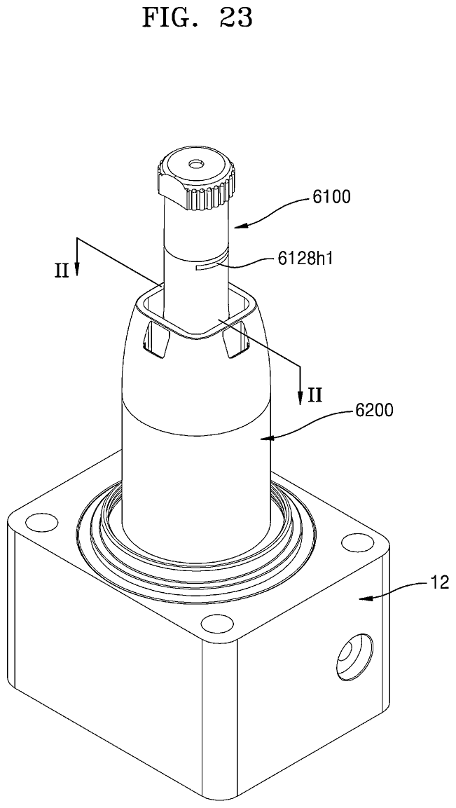

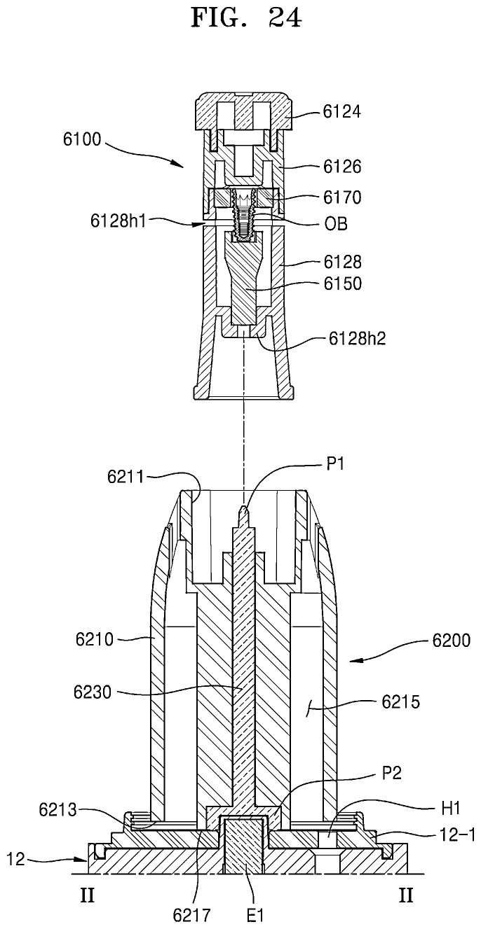

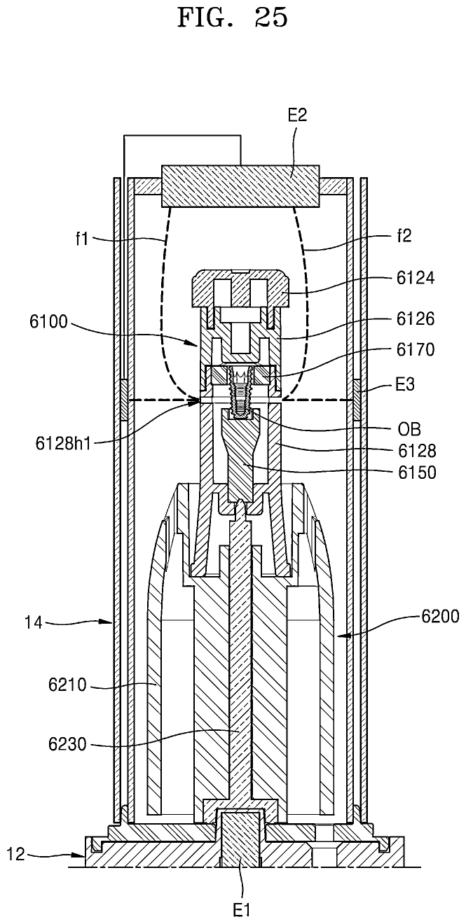

Referring to FIG. 10, the accommodation portion 200 according to another embodiment of the present disclosure may include a connection jig 230. The connection jig 230 may be installed inside the accommodation portion 200 and may be disposed to be movable in a preset direction.

The connection jig 230 may be connected to the packaging container 100 in which the treatment target OB is accommodated and may be made of a conductive material to be electrically connected to the packaging container 100. Specifically, one side (lower side in FIG. 10) of the connection jig 230 may be connected to the first electrode 310, and the other side (upper side in FIG. 10) opposite to the one side may be connected to the packaging container 100, specifically, the electrical connection member 115 provided in the housing portion 110.

Referring to FIG. 10, due to the packaging container 100 being disposed on the connection jig 230, the permeable portion 112, which is provided in the packaging container 100, specifically, the housing portion 110 and in which the hole 112h is formed, may be disposed to face the second electrode 350 installed in the accommodation portion 200, an electric field may be generated between the first electrode 310 receiving power from the power source 600, and the electrical connection member 115 and the second electrode 350 which are electrically connected to each other through the connection jig 230, and plasma discharge may be generated to perform plasma surface treatment on the treatment target OB accommodated in the packaging container 100.

Referring to FIGS. 1 and 11A to 9C, the electrode portion 300 according to an embodiment of the present disclosure may be disposed outside the packaging container 100 and may be installed in the accommodation portion 200. The electrode portion 300 may receive power from the outside, specifically, the power source 600, to generate an electric field for generating plasma in an inner space of the housing portion 110 surrounding the treatment target OB.

Referring to FIGS. 1 and 11A to 9C, the electrode portion 300 according to an embodiment of the present disclosure may include the first electrode 310 and the second electrode 350 disposed to be spaced apart from the first electrode 310. The first electrode 310 and the second electrode 350 may be electrically connected to the power source 600 to receive power from the power source 600.

When power is applied to the electrode portion 300, plasma may be generated in the inner space of the housing portion 110, in which the treatment target OB is accommodated, by a voltage difference between the first electrode 310 and the second electrode 350. The first electrode 310 may be formed as a high-voltage electrode, and the second electrode 350 may be a ground electrode to which no voltage is applied and may maintain a ground (0 V).

The electrode portion 300 according to an embodiment of the present disclosure may be disposed outside the packaging container 100 in which the treatment target OB is accommodated. The electrode portion 300 may receive high-voltage power from the power source 600 to generate an electric field, thereby generating plasma inside the packaging container 100, specifically, the housing portion 110.

Referring to FIG. 11C, when an electric field is generated according to the present disclosure, a low pressure environment and a vacuum area may be formed, plasma discharge may be uniformly generated in the inner space of the housing portion 110 that accommodates the treatment target OB, and plasma may be generated in the inner space to perform plasma surface treatment on the treatment target OB.

Referring to FIG. 1, according to an embodiment of the present disclosure, the electrode portion 300, specifically, the second electrode 350, may be disposed on one surface of the accommodation portion 200 to face the hole 112h formed in the permeable portion 112 provided in the packaging container 100, specifically, the housing portion 110.

As a result, when power is applied to the first electrode 310 and the second electrode 350, an electric field may be generated inside the packaging container 100 through the hole 112h formed in the housing portion 110, specifically, the permeable portion 112.

Referring to FIG. 1, according to an embodiment of the present disclosure, the second electrode 350, the permeable portion 112 provided in the packaging container 10, specifically, the housing portion 110, and the electrical connection member 115 may be aligned in a preset direction (vertical direction in FIG. 1).

Referring to FIG. 9, unlike the electrode portion 300 according to an embodiment of the present disclosure, the first electrode 310 and the second electrode 350 may be disposed not to face each other. Within the technical idea in which the electrical connection member 115 in contact with the first electrode 310 is electrically connected to the treatment target OB, the second electrode 350, the permeable portion 112, and the treatment target OB may be aligned in a preset direction (lateral direction in FIG. 9).

Referring to FIGS. 1 and 9, the electrode portion 300, specifically, the first electrode 310 and the second electrode 350, may receive power from the power source 600 and generate an electric field, plasma may flow into the housing portion 110 through the permeable portion 112 disposed to face the second electrode 350, and there may be an effect in which plasma surface treatment may be performed on the treatment target OB accommodated inside the housing portion 110.

That is, an electric field may be generated inside the housing portion 110, in which the treatment target OB is accommodated, through the permeable portion 112 formed in the packaging container 100, specifically, the housing portion 110, by the electrical connection member 115 and the second electrode 350 disposed externally.

Referring to FIGS. 1 and 11A to 11C, the airtightness forming portion 400 according to an embodiment of the present disclosure may be connected to the accommodation portion 200, in which the packaging container 100 is accommodated, and may be in direct or indirect contact with the packaging container 100.

The airtightness forming portion 400 may form a sealed area including the inside of the packaging container 100 in which the treatment target OB is accommodated.

In the present specification, the “sealed area” may be an area from which the gas G such as air is exhausted to the outside as the pressure adjustment portion 500 to be described below is driven, may be refer to an area in which a flow path of the gas G is not formed except for the airtightness forming portion 400, and may include the inside of the accommodation portion 200 and the inside of the packaging container 100 accommodated in the accommodation portion 200.

Referring to FIGS. 1 and 11A to 11C, the pressure adjustment portion 500 according to an embodiment of the present disclosure may form the low-pressure atmosphere LPA inside the sealed area including the inside of the packaging container 100 and may be connected to the airtightness forming portion 400.

The pressure adjustment portion 500 according to an embodiment of the present disclosure may include a pressure adjustment hole (not shown) formed to face the hole 112h formed in the packaging container 100, and an exhaust portion that evacuates the inside of the sealed area through the pressure adjustment hole (not shown).

The exhaust portion may be driven by receiving power from the outside, and the gas G, which passes through the hole 112h formed in the packaging container 100 and is exhausted to the outside of the packaging container 100, may pass through the airtightness forming portion 400 to be exhausted to the outside through the pressure adjustment hole.

Referring to FIGS. 1 and 11A to 11C, the pressure adjustment portion 500 may allow the gas G to flow from the inside of the accommodation portion 200, which includes the inside of the packaging container 100, to be exhausted to the outside, thereby adjusting internal pressure of the sealed area which is formed inside the accommodation portion 200 and includes the inside of the packaging container 100.

Specifically, a fluid, specifically, the gas G such as air, may be exhausted from the sealed area to the outside, thereby making the sealed area into a state of the relatively low-pressure atmosphere LPA.

Referring to FIGS. 1 and 11A to 11C, the pressure adjustment portion 500 according to an embodiment of the present disclosure may be connected to the accommodation portion 200 capable of accommodating the packaging container 100, and may exhaust air from the sealed area including the inside of the packaging container 100 to the outside through the airtightness forming portion 400.

As the pressure adjustment portion 500 according to an embodiment of the present disclosure is driven, the gas G such as air inside the packaging container 100 may be exhausted to the outside, a low-pressure environment for plasma generation may be made inside the packaging container 100, and a vacuum area may be formed.

Referring to FIGS. 1 and 11A to 11C, the pressure adjustment portion 500 according to an embodiment of the present disclosure is formed as a pump type and exhausts air inside the packaging container 100, specifically the housing portion 110, to the outside, but the present disclosure is not limited thereto. Various modifications are possible within the technical idea in which internal pressure of the packaging container 100 is formed in a low pressure state.

Although not shown in the drawings, the pressure adjustment portion 500 may include a valve and a filter.

Referring to FIGS. 1 and 11A to 11C, the power source 600 according to an embodiment of the present disclosure may be electrically connected to the electrode portion 300 and may generate power and transmit the generated power to the electrode portion 300.

The power source 600 according to an embodiment of the present disclosure may apply power to the electrode portion 300, and thus an electric field may be generated between the first electrode 310 and the second electrode 350 which are disposed outside the packaging container 100, in which the treatment target OB is accommodated, specifically, the housing portion 110.

Referring to FIGS. 11A to 11C, there is an effect in which an electric field may be concentrated inside the packaging container 100 disposed between a plurality of electrode portions 300, and plasma treatment efficiency may be improved upon treatment of the surface of the treatment target OB disposed inside the packaging container 100, specifically, the housing portion 110.

A plasma treatment method using the plasma treatment apparatus 1 according to an embodiment of the present disclosure as described above will be described.

Referring to FIGS. 1, 11A to 11C, and 13, the plasma treatment method according to an embodiment of the present disclosure may include operation S10 of preparing to accommodate a packaging container, operation S20 of accommodating the packaging container, in which a treatment target is accommodated, in an accommodation portion, operation S30 of forming a low-pressure atmosphere inside the packaging container, operation S40 of generating an electric field inside the accommodation portion, and operation S50 of discharging the low-pressure atmosphere to plasma-treat the treatment target.

Referring to FIG. 13, operation S10 of preparing to accommodate the packaging container may be an operation of, before accommodating the packaging container 100 in the plasma treatment apparatus 1, preparing the packaging container 100, and positions of the packaging container 100 and the treatment target OB accommodated in the packaging container 100 may be adjusted such that a shape/intensity of the electric field may be concentrated around the treatment target OB.

Operation S10 of preparing to accommodate the packaging container may include operation S11 of opening the hole 112h formed in the packaging container 100 or deforming a size or shape of the hole 112h, and operation S13 of adjusting the position of the treatment target OB or coupling the packaging container 100 to the connection jig 230.

Referring to FIGS. 2 to 10, in operation S11 of opening the hole 112h formed in the packaging container 100 or deforming the size or shape of the hole 112h, at least one hole 112h formed in the packaging container 100 according to embodiments of the present disclosure, specifically, the permeable portion 112 provided in the housing portion 110, may be opened, or the size or shape of the hole 112h may be deformed.

The housing portion 110 may include a plurality of housing bodies, and the hole 112h formed in the packaging container 100 may be opened or closed according to relative movement between the plurality of housing bodies.

That is, before the packaging container 100 is accommodated in the plasma treatment apparatus 1, specifically, the accommodation portion 200, when the pressure adjustment portion 500 is driven later, the gas G may be exhausted from the inside of the packaging container 100 to the outside through the hole 112h formed in the packaging container 100, and the low-pressure atmosphere LPA may be formed (S30).

As an alternative embodiment, an external force may be applied to the permeable portion 112 to deform the size or shape of at least one hole 112h formed in the permeable portion 112.

Referring to FIG. 13, in operation S13 of adjusting the position of the treatment target OB or coupling the packaging container 100 to the connection jig 230, a position of the treatment target OB may be adjusted such that the treatment target OB accommodated inside the packaging container 100 passes through the permeable portion 112 and approaches the electrode portion 300 of the plasma treatment apparatus 1, specifically, the second electrode 350.

Referring to FIG. 10, the accommodation portion 200 according to another embodiment of the present disclosure may include the connection jig 230, and the packaging container 100 may be disposed on the connection jig 230. Thus, the packaging container 100 may be provided, and the permeable portion 112 in which at least one hole 112h is formed may be disposed to face the electrode portion 300 positioned externally, specifically, the second electrode 350.

As a result, when power is applied to the second electrode 350 and the first electrode 310, and an electric field is generated, plasma may flow into the packaging container 100, specifically, the housing portion 110, through the hole 112h facing the second electrode 350, and plasma discharge may be facilitated inside the housing portion 110 in which the treatment target OB is accommodated, thereby improving plasma treatment efficiency.

Referring to FIGS. 1 and 13, in operation S20 of accommodating the packaging container, in which the treatment target is accommodated, in the accommodation portion, the packaging container 100 in which the treatment target OB is accommodated may be disposed in the accommodation portion 200, and the packaging container 100 may be stably positioned and fixed in the accommodation portion 200.

Referring to FIG. 1, the packaging container 100 may be accommodated in the accommodation portion 200, and an inner space of the accommodation portion 200 including the inner space of the packaging container 100 may be sealed to form a sealed area.

Although not shown in the drawings, the plasma treatment apparatus 1 may include a sensor, and the sensor may detect whether the airtightness forming portion 400 is in contact with and connected to the accommodation portion 200 in which the packaging container 100 is accommodated.

The sensor detects whether the entire areas in which the accommodation portion 200 and the airtightness forming portion 400 are in contact with each other are in proper contact with each other, and thus there is an effect in which, in a state in which the entire areas are in close contact with each other, the pressure adjustment portion 500 may be driven to adjust pressure inside the packaging container 100.

Referring to FIGS. 11A, 11B, and 13, in operation S30 of forming the low-pressure atmosphere inside the packaging container, as the pressure adjustment portion 500 is driven, the gas G such as air in the inner space of the accommodation portion 200 including the inside of the packaging container 100 may be exhausted to the outside of the accommodation portion 200 to form the low-pressure atmosphere LPA.

Referring to FIGS. 11A and 11B, as the pressure adjustment portion 500 is driven, the gas G such as air inside the packaging container 100 may be exhausted into the accommodation portion 200 through the permeable portion 112 in which the hole 112h is formed and may be exhausted to the outside through the airtightness forming portion 400 connected to the accommodation portion 200.

As a result, inside the housing portion 110 in which the treatment target OB is accommodated, a low-pressure environment in which plasma discharge for surface treatment of the treatment target OB may be made, and a vacuum area may be formed so that plasma may be generated to be concentrated in the inside in which the treatment target OB is accommodated.

Referring to FIG. 11C, in operation S40 of generating the electric field inside the accommodation portion 200, the electric field may be generated between the electrode portions 300 receiving power from the power source 600, specifically, between the first electrode 310 and the second electrode, and the electric field may be generated to be concentrated inside the accommodation portion 200 in which the packaging container 100 is accommodated.

Referring to FIG. 11C, in operation S50 of plasma-treating the treatment target OB, a low pressure environment and a vacuum area may be formed inside the accommodation portion 200, plasma discharge may be generated in the inner space of the housing portion 110 that accommodates the treatment target OB, and plasma may flow into the packaging container 100 from the inside of the accommodation portion 200 through the hole 112h formed in the packaging container 100, specifically, the permeable portion 112 provided in the housing portion 110.

As a result, plasma discharge may be generated inside the packaging container 100 in which the treatment target OB is accommodated, and plasma treatment may be performed on the surface of the treatment target OB.

Hereinafter, the configuration, operating principle, and effects of a plasma treatment apparatus 2 according to another embodiment of the present disclosure will be described.

Referring to FIGS. 12A to 12C, the plasma treatment apparatus 2 according to another embodiment of the present disclosure may include a packaging container 100, an accommodation portion (not shown), an electrode portion 300, an airtightness forming portion 400, a pressure adjustment portion 500, and a power source 600.

Referring to FIGS. 12A to 12C, in the plasma treatment apparatus 2 according to another embodiment of the present disclosure, like the plasma treatment apparatus 1 according to an embodiment of the present disclosure, the packaging container 100 according to embodiments of the present disclosure shown in FIGS. 2 to 9 may be applied.

Referring to FIGS. 12A to 12C, in the plasma treatment apparatus 2 according to another embodiment of the present disclosure, unlike the plasma treatment apparatus 1 according to an embodiment of the present disclosure in which the airtightness forming portion 400 is connected to the accommodation portion 200, the airtightness forming portion 400 may be directly connected to the packaging container 100.

Referring to FIGS. 12A to 12C, the airtightness forming portion 400 according to another embodiment of the present disclosure may include an airtightness sealing portion 410. The airtightness sealing portion 410 may be disposed between the airtightness forming portion 400 and the packaging container 100, specifically, between the airtightness forming portion 400 and the housing portion 110, and may be disposed to surround a permeable portion 112 provided in the housing portion 110.

The airtightness sealing portion 410 may be made of a material that is elastically deformable and may be formed in a ring shape. As a result, there is an effect in which gas G such as air may be prevented from leaking to the outside between the packaging container 100 and the airtightness forming portion 400, and as the pressure adjustment portion 500 is driven, internal pressure of the packaging container 100 may be adjusted, and a low-pressure atmosphere LPA may be formed.

In addition, the airtightness sealing portion 400 may improve the airtightness of a sealed area formed as an inner space of the packaging container 100 together with the airtightness forming portion 400.

Referring to FIGS. 12A to 12C, the electrode portion 300 is disposed in the accommodation portion (not shown), and the packaging container 100 may be accommodated inside the accommodation portion.

The plasma treatment apparatus 2 according to another embodiment of the present disclosure may have the same configuration and effects as the plasma treatment apparatus 1 according to an embodiment of the present disclosure, except that the airtightness forming portion 400 is directly connected to the packaging container 100, and thus redundant detailed descriptions will be omitted.

Hereinafter, a packaging container and a plasma treatment apparatus according to another embodiment of the present disclosure (hereinafter referred to as “third embodiment”) will be described.

FIG. 14 is a perspective view illustrating the packaging container according to the third embodiment of the present disclosure. FIG. 15 is a cross-sectional view taken along line I-I of FIG. 14. FIG. 16 is a plan view of FIG. 14. FIG. 17 is a perspective view illustrating the plasma treatment apparatus according to the third embodiment of the present disclosure.

Referring to FIG. 14, a packaging container 3100 may include a housing portion 3110, a holding member 3130, a holder block 3140, and an electrical connection member 3150. The housing portion 3110 may include a first housing body 3111 and a second housing body 3112 that are detachable from each other.

Here, the first housing body 3111 may be an upper member disposed adjacent to a treatment target OB, which is an implant fixture, and the second housing body 3112 may be a lower member fitted into the upper member.

Referring to FIGS. 14 and 17, the holder block 3140 and the electrical connection member 3150 may be accommodated in the second housing body 3112. A hole capable of communicating with the outside may be formed in one surface of the first housing body 3111. Specifically, the packaging container 3100 may be mounted on the plasma treatment apparatus 3 and may be exposed to a low-pressure environment in an accommodation portion.

In this case, in order to perform plasma surface treatment on the treatment target OB accommodated inside the housing portion 3110, a hole through which air may be circulated to a surrounding environment may be formed in the first housing body 3111.

Referring to FIGS. 14 and 15, the holding member 3130 may perform a function of supporting the treatment target OB at a certain level inside the housing portion 3110. Specifically, the holding member 3130 may include a body 3131 having the other end E2 opposite to an end E1 connected to the treatment target OB, and a protrusion 3133 protruding from an outer surface of the body 3131.

Referring to FIGS. 14 and 15, the holder block 3140 may fix the holding member 3130. The holding member 3130 may partially pass through the holder block 3140, and the treatment target OB may be positioned at a central portion of the packaging container 3100 and fixed so as not to fall.

The electrical connection member 3150 is made of a conductive material and has the same structure and effects as the electrical connection member 3150 according to the embodiments described above, and thus detailed descriptions will be omitted.

Referring to FIG. 15, an elastic member 3160 may be disposed on the holder block 3140 and may fix the holding member 3130 seated on the holder block 3140, specifically, an upper portion of the protrusion 3133. A guard member 3170 may surround the treatment target OB inside the housing portion 3110, may perform a function of protecting the treatment target OB, and may perform an inner communication function inside the housing portion 3110.

Due to the guard member 3170, when the treatment target OB is taken out from the housing portion 3110, the treatment target OB may be protected not to come into direct contact with a floor or the like.

As an alternative embodiment, referring to FIG. 16, a first hole 3111h may be formed in the first housing body 3111, and a second hole 3115h may be formed in an inner housing body 3115 disposed inside the first housing body 3111.

As the holes formed in the first housing body 3111 and the inner housing body 3115 communicate with each other, air inside the packaging container 3100 may be smoothly exhausted.

As a result, before plasma surface treatment is performed on the treatment target OB, the inside of the packaging container 3100 may be easily made into a vacuum state through the first hole 3111h and the second hole 3115h. Thereafter, during plasma surface treatment of the treatment target OB, an electric field may be well transmitted through the first hole 3111h and the second hole 3115h.

That is, a plasma movement path may be formed through the first hole 3111h and the second hole 3115h so that plasma may be easily generated inside the packaging container 3100. Accordingly, there is an effect in which plasma surface treatment may be easily performed on the treatment target OB through the first hole 3111h and the second hole 3115h.

The first housing body 3111 and the inner housing body 3115 may share a central axis and may rotate about on the central axis clockwise or counterclockwise. Accordingly, the first hole 3111h and the second hole 3115h may not communicate with each other or may not overlap each other.

Referring to FIG. 17, the plasma treatment apparatus 3 according to the third embodiment may include a seating portion 12 on which the packaging container 3100 is seated, an airtightness portion 14 that moves relative to the seating portion 12 to seal the packaging container 3100 from an external environment, a treatment portion (not shown) that discharges plasma inside the airtightness portion 14 sealed from the external environment, an exhaust portion (not shown) that exhausts air inside the airtightness portion 14 sealed from the external environment, an upper block 13 disposed above the seating portion 12, and a body 11 forming an exterior.

Since the plasma treatment apparatus 3 in which the packaging container 3100 according to the third embodiment of the present disclosure is accommodated, and a plasma treatment method are the same as the plasma treatment apparatus and the plasma treatment method according to the embodiments described above, redundant detailed descriptions will be omitted.

Hereinafter, a packaging container and a plasma treatment apparatus according to another embodiment of the present disclosure (hereinafter referred to as “fourth embodiment”) will be described.

FIG. 18 is a perspective view illustrating the packaging container according to the fourth embodiment of the present disclosure.

Referring to FIG. 18, a packaging container 4100 according to the fourth embodiment of the present disclosure may include a housing portion 4110 and an electrical connection member 4150. The housing portion 4110 may include a first housing body 4111, a second housing body 4112, and an inner housing body 4115 that are detachable from each other.

The first housing body 4111 may be an upper member disposed adjacent to a treatment target OB, and the second housing body 4112 may be a lower member fitted into the upper member.

The inner housing body 4115 may accommodate the treatment target OB therein, and the first housing body 4111 may surround the inner housing body 4115. The inner housing body 4115, the first housing body 4111, and the second housing body 4112 may protect the treatment target OB.

Referring to FIG. 18, a support member 4140 may support one end of the treatment target OB. As a result, the support member 4140 may prevent the treatment target OB from falling and may perform a function of stably fixing and storing the treatment target OB by preventing the treatment target OB from deviating from a horizontal center of the packaging container 4100.

Referring to FIG. 18, the electrical connection member 4150 is made of a conductive material and has the same configuration and effects as the electrical connection member 4150 according to the embodiments described above, and thus detailed descriptions will be omitted.

Referring to FIG. 18, a holder block 4160 may surround and fix the electrical connection member 4150. Thus, the holder block 4160 may more stably fix the treatment target OB supported by the electrical connection member.

Referring to FIG. 18, the holder block 4160 may be connected and coupled to the inner housing body 4115 and may be made of an insulating material, thereby allowing an electrical connection with the treatment target OB to be directly made through the electrical connection member.

Referring to FIG. 18, a fixing member 4170 may be disposed between the inner housing body 4115 and the holder block 4160 and may fix the treatment target OB. Thus, there is an effect in which the fixing member 4170 may stably fix and store the treatment target OB together with the support member 4140, the inner housing body 4115, and the electrical connection member 4150.

Since the plasma treatment apparatus in which the packaging container 4100 according to the fourth embodiment of the present disclosure is accommodated, and a plasma treatment method are the same as the plasma treatment apparatus and the plasma treatment method according to the embodiments described above, redundant detailed descriptions will be omitted.

Hereinafter, a packaging container and a plasma treatment apparatus according to another embodiment of the present disclosure (hereinafter referred to as “fifth embodiment”) will be described.

FIG. 19 is a perspective view illustrating that an opening/closing portion of the plasma treatment apparatus according to the fifth embodiment of the present disclosure is opened. FIG. 20 is a conceptual view illustrating the packaging container according to the fifth embodiment of the present disclosure. FIG. 21 is a perspective view illustrating the inside of the plasma treatment apparatus according to the fifth embodiment of the present disclosure.

Referring to FIG. 20, a packaging container 5100 according to the fifth embodiment of the present disclosure may include a fixing member 5110, a housing portion 5200, and an electrical connection member 5300.

Referring to FIG. 20, the fixing member 5110 may support a bottom surface of a treatment target OB to fix the treatment target OB. The fixing member 5110 may have a fixing force which is for fastening to the treatment target OB and counteracts an external force for taking out the treatment target OB from the packaging container 5100.

The external force for taking out the treatment target OB from the packaging container 5100 may be a rotational force, and the fixing force may be a rotation prevention force. A user may take out the treatment target OB from the packaging container 5100 by gripping the treatment target OB through a grip hole OBh.

Specifically, after plasma surface treatment is performed on the treatment target OB, a user may turn over the packaging container 5100 to grip the treatment target OB. The treatment target OB is exposed through an open lower portion of the packaging container 5100, and a user may grip the treatment target OB through the grip hole OBh by using a gripping tool.

Specifically, a user may insert and couple the gripping tool into the grip hole OBh by rotating the gripping tool about a central axis of the grip hole OBh clockwise or counterclockwise.

In this case, the fixing member 5110 may have a fixing force which is for fastening to the treatment target OB and counteracts an external force for taking out the treatment target OB from the packaging container 5100, that is, a rotational force clockwise or counterclockwise.

That is, while a user rotates the gripping tool to grip the treatment target OB, the fixing member 5110 may have the fixing force that is the rotation prevention force for preventing the treatment target OB from rotating together with the gripping tool and fixing the treatment target OB.

Accordingly, a user may use the gripping tool to grip the treatment target OB without direct contact with the treatment target OB and without contamination or damage of the treatment target OB.

The fixing member 5110 may include a plurality of fixing protrusions 5120 protruding from an upper surface. The fixing protrusion 5120 may be disposed along an inner circumference of the treatment target OB and may be fastened to an inner surface of the treatment target OB. Accordingly, the fixing protrusion 5120 may stably fix the treatment target OB and may have the rotation prevention force.

The fixing protrusion 5120 may move in relation to the size and shape of the treatment target OB so as to fix the treatment target OB having various sizes and shapes.

Referring to FIG. 20, the housing portion 5200 may cover and accommodate the treatment target OB and the fixing member 5110.

The housing portion 5200 has an effect capable of preventing contamination and damage of the treatment target OB by preventing the treatment target OB from coming into contact with an external environment while a user grips the treatment target OB and turns over the housing portion 5200 to separate the treatment target OB from the fixing member 5110.

The housing portion 5200 may have a shape corresponding to the shape of the treatment target OB for uniform plasma discharge therein.

Although not shown in the drawings, a permeable portion may be provided at a lower portion (see FIG. 20) of the housing portion 5200. The permeable portion may have at least one hole (not shown) formed therein and may only allow the flow of gas such as air. The permeable portion may be made of a gas-permeable film.

The housing portion 5200 may include a first housing body 5500 (5120) and a second housing body 5500 (5220). The second housing body 5500 (5220) may cover the treatment target OB and the fixing member 5110, and the first housing body 5500 (5120) may cover the second housing body 5500 (5220).

Referring to FIG. 20, one side of the electrical connection member 5300 may be electrically connected to the treatment target OB, and the other side thereof may be electrically connected to an external electrode. The electrical connection member 5300 may be made of a conductive material and may include a contact portion 5310 that may be in contact with the treatment target OB.

The contact portion 5310 may be in contact with an inner surface of the treatment target OB to be electrically connected to the treatment target OB. The contact portion 5310 may be disposed along a circumference of the treatment target OB and fastened to the inner surface of the treatment target OB.

Accordingly, the contact portion 5310 may have a fixing force for fixing the treatment target OB together with the fixing protrusion 5120 provided in the fixing member 5110.

Since the electrical connection member 5300 is the same as the electrical connection member 5300 according to the above-described embodiments except for the contact portion 5310, detailed description is omitted.

Referring to FIG. 19, the plasma treatment apparatus 5 according to the fifth embodiment of the present disclosure may include a body 5500, a chamber 5600, an opening/closing portion 5700, and an exhaust portion.

The body 5500 may include a base 5510, a frame 5520, and a case 5530.

The base 5510 may constitute a lower portion of the body 5500, the frame 5520 may be disposed on an upper surface of the base 5510 to support the chamber 5600 and the opening/closing portion 5700, and the case 5530 may be disposed on the base 5510 and the frame 5520 to form an exterior of the body 5500.

The chamber 5600 may be disposed on the body 5500 and may accommodate the packaging container 5100. The chamber 5600 may include a seating portion 5610, a sealing portion 5630, and a first electrode 5640.

The seating portion 5610 may have an accommodation space 5611. The packaging container 5100 may be accommodated in the accommodation space 5611. In an embodiment, the accommodation space 5611 may have a shape corresponding to a shape of the packaging container 5100, and thus the packaging container 5100 may be fixed to the seating portion 5610.

The seating portion 5610 may be connected to the exhaust portion 5800 and may have an exhaust hole 5612 for evacuating the inside of the packaging container 5100. In exemplary embodiments, the seating portion 5610 may be spaced apart from the packaging container 5100 to form an exhaust space 5620.

In an embodiment, the seating portion 5610 may include a rib 5613 at a portion, on which the packaging container 5100 is seated, and thus may be spaced apart from the packaging container 5100, thereby forming an exhaust path.

Before plasma surface treatment is performed on the treatment target OB, the inside of the packaging container 5100 may be smoothly evacuated through the exhaust space 5620 between the seating portion 5610 and the packaging container 5100 and the exhaust path provided by the rib 5613.

The sealing portion 5630 may be disposed in the accommodation space 5611 of the seating portion 5610 and may seal the seating portion 5610 and the packaging container 5100. Accordingly, the sealing portion 5630 may form a certain space, which surrounds the treatment target OB in the packaging container 5100, as a sealed area.

The first electrode 5640 may be disposed at a lower portion of the chamber 5600 and exposed through the accommodation space 5611.

When the packaging container 5100 is accommodated in the seating portion 5610, the first electrode 5640 may be in contact with and electrically connected to the electrical connection member 5300. In example embodiments, the first electrode 5640 may have a shape corresponding to a shape of the electrical connection member 5300 exposed to the outside.

In exemplary embodiments, the first electrode 5640 may be made of a magnetic material to secure connectivity with the electrical connection member 5300.

In example embodiments, the chamber 5600 may be made of a dielectric material.

In an embodiment, the chamber 5600 may have a configuration that is separate from the body 5500 and replaceable. Since a surface of the chamber 5600 made of a dielectric material may be oxidized and damaged as plasma surface treatment is repeatedly performed, the chamber 5600 may have a configuration that may be separated from and coupled to the body 5500.

In addition, since the chamber 5600 may be separated from and coupled to the body 5500, the chamber 5600 having the accommodation space 5611 with various shapes may be adopted, and thus the plasma treatment apparatus 5 may perform plasma surface treatment on the packaging container 5100 with various shapes.

The opening/closing portion 5700 may be disposed on the chamber 5600 to open and seal the chamber 5600. The opening/closing portion 5700 may be rotatably installed on the chamber 5600 to open or close the accommodation space 5611 of the chamber 5600. The opening/closing portion 5700 may include a rotating portion 5710, a door member 5720, a cover portion 5730, and a second electrode 5740.

The rotating portion 5710 may be connected to the chamber 5600 to rotate the opening/closing portion 5700.

The door member 5720 may form an exterior of the opening/closing portion 5700 and may be connected to the rotating portion 5710 and rotated by the rotating portion 5710 to open or close the chamber 5600. The cover portion 5730 may pass through the door member 5720 to form the exterior of the opening/closing portion 5700 together with the door member 5720 and may cover the packaging container 5100.

In addition, since the cover portion 5730 covers the accommodation space 5611, the accommodation space 5611 may be opened or closed by the rotating portion 5710.

The second electrode 5740 may be disposed at a lower portion of the cover portion 5730. In an embodiment, the second electrode 5740 may be made of a transparent material or may have a mesh structure for external visibility.

In example embodiments, the second electrode 5740 may be made of a material that may withstand high temperature and high voltage during plasma discharge.

In exemplary embodiments, in order to generate uniform plasma discharge PD inside the packaging container 5100, the cover portion 5730 and the second electrode 5740 may have a shape corresponding to the shape of the packaging container 5100.

In example embodiments, the door member 5720 and the cover portion 5730 may be made of an insulating material. Since the door member 5720 and the cover portion 5730 cover a portion except for a bottom surface of the second electrode 5740, when a user grips the opening/closing portion 5700 to open or close the opening/closing portion 5700, the user may be prevented from receiving an electric shock.

In an embodiment, the bottom surface of the second electrode 5740 may be exposed toward the packaging container 5100. In another embodiment, the bottom surface of the second electrode 5740 may be covered with a dielectric material and not exposed to the outside.

An exhaust portion 5800 may include an exhaust pump 5810 and a manifold 5820. The exhaust pump 5810 may communicate with the exhaust hole 5612 to exhaust air from a sealed area 5420. A plurality of exhaust pumps 5810 may be provided and connected in parallel or series.

The manifold 5820 may determine a connection method of the exhaust pumps 5810. In exemplary embodiments, the manifold 5820 may connect the exhaust pumps 5810 in parallel to evacuate the sealed area 5420 and then may connect the exhaust pumps 5810 in series to evacuate the sealed area 5420.

Although FIG. 21 illustrates two exhaust pumps 5810, the present disclosure is not necessarily limited thereto, and three or more exhaust pumps 5810 may be provided.

Since a plasma treatment method using the plasma treatment apparatus in which the packaging container 5100 according to the fifth embodiment of the present disclosure is accommodated is the same as the plasma treatment method according to the embodiments described above, redundant detailed descriptions will be omitted.

Hereinafter, a packaging container and a plasma treatment apparatus according to another embodiment of the present disclosure (hereinafter referred to as “sixth embodiment”) will be described.

FIG. 22 is a view illustrating an embodiment in which the packaging container is accommodated in the plasma treatment apparatus according to the sixth embodiment of the present disclosure by using a connection jig for a plasma treatment apparatus. FIG. 23 is a perspective view illustrating the connection jig for a plasma treatment apparatus according to the sixth embodiment of the present disclosure. FIG. 24 is a cross-sectional view taken along line II-II of FIG. 23. FIG. 25 is a view for describing an operation in a state in which the packaging container and the connection jig are applied to the plasma treatment apparatus according to the sixth embodiment of the present disclosure.

FIG. 22 is a view illustrating an embodiment in which a packaging container 6100 is accommodated in a plasma treatment apparatus 6 by using a connection jig 6200 for a plasma treatment apparatus according to the sixth embodiment of the present disclosure.

Referring to FIG. 22, the plasma treatment apparatus 6 according to the sixth embodiment of the present disclosure may include a seating portion 12 on which the connection jig 6200 for a plasma treatment apparatus is seated, an airtightness portion 14 that moves relative to the seating portion 12 to seal the connection jig 6200 for a plasma treatment apparatus from an external environment, a treatment portion E1, E2, and E3 (see FIG. 25) that discharges plasma inside the airtightness portion 14 sealed from the external environment, an exhaust portion (not shown) that exhausts air inside the airtightness portion 14 sealed from the external environment, an upper block 13 disposed above the seating portion 12, and a body 11 forming an exterior.

The seating portion 12 may be positioned in front of the body 11 and may be positioned below the upper block 13. An electrode that applies power to a treatment target holding device 100 may be formed on an upper surface of the seating portion 12.

In this case, a hole 12-1 (see FIG. 24) for accommodating a coupling portion 6213 of the connection jig 6200 for a plasma treatment apparatus may be formed in the seating portion 12.

In addition, the seating portion 12 may include a magnet, and thus a contact force with the connection jig 6200 for a plasma treatment apparatus, in particular, a jig connection portion 6230 of the connection jig 6200, may be reinforced through a magnetic force. The magnet may be provided on a bottom surface of the hole 12-1.

The airtightness portion 14 moves relative to the seating portion 12 to seal the connection jig 6200 for a plasma treatment apparatus from an external environment. In the present disclosure, as an example, the airtightness portion 14 is elevated, and thus a lower portion of the airtightness portion 14 comes into contact with the upper surface of the seating portion 12, thereby forming a sealed space inside the airtightness portion 14.

The upper block 13 may be disposed to be positioned in front of the body 11 and above the seating portion 12. The upper block 13 may include an elevation portion (not shown) that elevates the airtightness portion 14.

When the airtightness portion 14 is lowered and the seating portion 12 and the airtightness portion 14 are sealed, the treatment portion may perform a plasma treatment function by discharging plasma in a hollow inside of the airtightness portion 14 forming the sealed space.

The treatment portion may include a first electrode E1 (see FIG. 25) provided in the seating portion 12 to be electrically connected to the connection jig 6200 for a plasma treatment apparatus, a second electrode E2 (see FIG. 25) provided at an upper portion of the airtightness portion 14 or in the upper block 13 to be disposed above the connection jig 6200 for a plasma treatment apparatus, a third electrode E3 (see FIG. 25) disposed at a side portion of the airtightness portion 14, and a power source that applies power to the first to third electrodes E1 to E3.

The exhaust portion (not shown) may perform a function of exhausting air inside the airtightness portion 14 sealed from the external environment. An exhaust hole H1 may be formed in the seating portion 12 to allow the airtightness portion 14 and the exhaust portion (not shown) to communicate with each other.

As described above, the connection jig 6200 for a plasma treatment apparatus according to embodiments of the present disclosure is accommodated in the plasma treatment apparatus 6 in a state in which a treatment target is seated through the accommodation portion.

Referring to FIGS. 22 to 24, the connection jig 6200 for a plasma treatment apparatus according to an embodiment of the present disclosure may be connected to the packaging container 6100 in which a treatment target OB is accommodated.

Here, the packaging container 6100 may include a cover, an electrical connection member 6150, and a fixing member 6170. The cover may include an upper cover 6124, a central cover 6126, and a lower cover 6128.

The upper cover 6124 may be coupled to an upper portion of the central cover 6126, and the lower cover 6128 may be coupled to a lower portion of the central cover 6126.

In an embodiment, a coupling between the upper cover 6124 and the central cover 6126 and a coupling between the lower cover 6128 and the central cover 6126 may be made by using a screw coupling method or a pressure fitting coupling method.

The cover may accommodate the treatment target OB therein, and the upper cover 6124, the central cover 6126, and the lower cover 6128 may perform a function of protecting the treatment target OB together. In an embodiment, the central cover 6126 may accommodate the treatment target OB therein.

The upper cover 6124, the central cover 6126, and the lower cover 6128 may be made of an insulating material, for example, a resin material. In addition, the upper cover 6124, the central cover 6126, and the lower cover 6128 may be made of a transparent material such that the treatment target OB accommodated therein may be checked. In an embodiment, the treatment target OB may be accommodated in the lower cover 6128. In addition, the lower cover 6128 may accommodate the electrical connection member 6150 and the fixing member 6170 which will be described below.

A through-hole 6128h1 may be formed in one surface of the cover. In exemplary embodiments, the through-hole 6128h1 may be formed in one surface of the cover which is perpendicular to a z-direction. In an embodiment, the through-hole 6128h1 may be formed in one surface of the lower cover 6128 which is perpendicular to the z-direction. Accordingly, a side surface of the treatment target OB may be exposed to the outside through the through-hole 6128h1.

The packaging container 6100 may communicate with the outside through the through-hole 6128h1. Specifically, before plasma surface treatment is performed on the treatment target OB, air inside the packaging container 6100 may be exhausted through the through-hole 6128h1.

In addition, during plasma surface treatment of the treatment target OB, the through-hole 6128h1 provides a path through which plasma moves to the treatment target OB, thereby performing plasma surface treatment on the treatment target OB through the through-hole 6128h1.

When the through-hole 6128h1 is not formed in one surface of the lower cover 6128 and the packaging container 6100 for a treatment target is completely sealed, it may be difficult for plasma to be generated inside the packaging container 6100 when plasma surface treatment is performed on the treatment target OB.

Specifically, the treatment target OB may serve as an electrode for generating plasma, but since the upper cover 6124 and the central cover 6126 have a high dielectric constant value and are completely sealed, an electric field may considerably decrease when passing through the upper cover 6124 and the central cover 6126, which may ultimately make it difficult for plasma to be generated inside the packaging container 6100.

First, air inside the packaging container 6100 for a treatment target may be smoothly exhausted through the through-hole 6128h1. As a result, before plasma surface treatment is performed on the treatment target OB, the inside of the packaging container 6100 may be easily made into a vacuum state through the through-hole 6128h1.

Thereafter, during plasma surface treatment of the treatment target OB, an electric field may be well transmitted through the through-hole 6128h1.

That is, a plasma movement path may be formed through the through-hole 6128h1, and thus plasma may be easily generated inside the packaging container 6100.

Thus, plasma surface treatment may be easily performed on the treatment target OB through the through-hole 6128h1.

In addition, since the through-hole 6128h1 is formed in one surface of the lower cover 6128 which is perpendicular to the z-direction, the uniformity of plasma surface treatment of the treatment target OB in the z-direction may be improved.

The fixing member 6170 may be disposed inside the lower cover 6128 and may perform a function of fixing the treatment target OB. Accordingly, the fixing member 6170, together with the electrical connection member 6150, may perform a function of stably fixing and storing the treatment target OB.

Referring to FIG. 24, the connection jig 6200 for a plasma treatment apparatus may include a housing member 6210 and the jig connection portion 6230.

The housing member 6210 may be made of a non-conductive material. For example, the housing member 6210 may be made of resin such as polypropylene (PP), polycarbonate (PC), polyacetal (POM), polystyrene, polyamide, polyethylene, rigid polyvinyl chloride, or an acrylonitrile-butadiene-styrene (ABS) copolymer.

The housing member 6210 may be made of a non-conductive material and may cover the jig connection portion 6230 made of a conductive material.

The connection jig 6200 for a plasma treatment apparatus may prevent exposure of the jig connection portion 6230 while plasma discharge is performed through the housing member 6210 and may allow plasma treatment to be performed to be concentrated to the treatment target OB.

Referring to FIG. 24, the housing member 6210 may further include a protrusion 6217 that protrudes outward from the coupling portion 6213 and is in contact with a plasma treatment apparatus 6 which is an external apparatus.

The protrusion 6217 may form a space such that the coupling portion 6213 is not in direct contact with a seating portion 612 for the plasma treatment apparatus 610, and thus air may smoothly flow in the exhaust hole H1 and an exhaust passage 6215.

For example, the protrusion 6217 may be disposed in a central area of the coupling portion 6213 so that the coupling portion 6213 may be lifted to a certain level when the housing member 6210 is seated on the seating portion 612, and one end of the exhaust passage 6215 may be opened toward the exhaust hole H1.

Referring to FIG. 25, in a state of being mounted on the connection jig 6200 for a plasma treatment apparatus, the packaging container 6100 in which the treatment target OB is accommodated may be seated on the seating portion 12 for the plasma treatment apparatus 6.

When the connection jig 6200 for a plasma treatment apparatus is seated, the plasma treatment apparatus 6 relatively moves the airtightness portion 14, which is a first member, toward the seating portion 12 which is a second member, thereby forming a space sealed from an external environment. A third member 12-1 (see FIG. 24) may be further included between the airtightness portion 14 and the seating portion 12 to improve a sealing force.

When the airtightness portion 14 and the seating portion 12 are coupled, the plasma treatment apparatus 6 may start to exhaust air by using an exhaust pump (not shown) and may form a low-pressure atmosphere in a preset pneumatic pressure range inside the airtightness portion 14.

When the inside of the airtightness portion 14 is in a low pressure state in the preset pneumatic pressure range, the plasma treatment apparatus 6 may use the treatment portion to generate an electric field inside the airtightness portion 14.

In this case, the treatment portion may include the first electrode E1 which is a lower electrode, the second electrode E2 which is an upper electrode, and the third electrode E3 disposed between the first electrode E1 and the second electrode E2.

The first electrode E1 may be provided on the seating portion 12 and may maintain a ground (0 V) as a ground electrode to which no voltage is applied. In this case, the treatment target OB electrically connected to the first electrode E1 may function as an electrode.

The second electrode E2 may be provided on an upper end of the airtightness portion 14 opposite to the seating portion 12 and may become a high-voltage portion by applying a preset voltage thereto. The second electrode E2 may interact with the first electrode E1 to generate an electromagnetic field.

As another embodiment, the first electrode E1 may become a high-voltage portion by applying a preset voltage thereto, and the second electrode E2 may maintain a ground as a ground electrode to which no voltage is applied, thereby generating an electromagnetic field.

The plasma treatment apparatus 6 according to the sixth embodiment of the present disclosure may include the third electrode E3.

Air inside the packaging container 6100 may be exhausted through the through-hole 6128h1, and accordingly, in the plasma treatment apparatus 6, before plasma surface treatment is performed on the treatment target OB, the inside of the packaging container 6100 may be easily made into a vacuum state through the through-hole 6128h1.

In this case, during plasma surface treatment of the treatment target OB, an electric field may be well transmitted through the through-hole 6128h1.

That is, a plasma movement path may be formed through the through-hole 6128h1, and thus plasma may be generated inside the packaging container 6100. However, when the treatment portion consists of only the first electrode E1 and the second electrode E2, it may be difficult to generate uniform plasma discharge inside the packaging container 6100 through the through-hole 6128h1 formed in a side surface of the packaging container 6100.

In order to overcome the difficulty, the third electrode E3 may be disposed between the first electrode E1 and the second electrode E2, specifically, may be provided on a side surface of the airtightness portion 14 adjacent to the through-hole 6128h1 of the packaging container 6100.

An imaginary line passing through the through-hole 6128h1 may pass through the third electrode E3. That is, the third electrode E3 may be disposed at a position facing the treatment target OB based on the through-hole 6128h1 and may directly generate an electric field through an interaction with the treatment target OB which is an electrode.

The third electrode E3 may be formed to surround the side surface of the airtightness portion 14 adjacent to the through-hole 6128h1 of the packaging container 6100. The third electrode E3 may be electrically connected to the second electrode E2 through a conducting wire, and thus the same level of voltage may be applied thereto.

The airtightness portion 14 may include an inner wall and an outer wall, and the third electrode E3 may be provided to be interposed between the inner wall and the outer wall of the airtightness portion 14. As an example, the third electrode E3 may be formed by being applied onto an outer surface of the inner wall and an inner surface of the outer wall.

In the plasma treatment apparatus 6 according to the sixth embodiment of the present disclosure, the inside of the packaging container 6100 having the through-hole 6128h1 may be easily made into a vacuum state, and then, while plasma surface treatment is performed on the treatment target OB, uniform plasma discharge may be generated.

The connection jig 6200 for a plasma treatment apparatus may position the packaging container 6100, in which the treatment target may, closer to the second electrode E2, which is the upper electrode, than the seating portion 12, thereby more efficiently generating an electric field.

In particular, the connection jig 6200 for a plasma treatment apparatus matches a position of the through-hole 6128h1 of the packaging container 6100 with a position of the third electrode E3 positioned in the airtightness portion, thereby improving plasma surface treatment uniformity.

Since a plasma treatment method using the plasma treatment apparatus 6 in which the packaging container 6100 according to the sixth embodiment of the present disclosure is accommodated is the same as the plasma treatment method according to the embodiments described above, redundant detailed descriptions will be omitted.

While the present disclosure has been described with reference to embodiments thereof, the present disclosure is not limited to the embodiments, and various modifications and changes may be made by those skilled in the art without departing from the technical spirit and scope of the present disclosure.

### INDUSTRIAL APPLICABILITY

According to an embodiment of the present disclosure, a packaging container, a plasma treatment apparatus, and a processing method are provided. In addition, embodiments of the present disclosure may be applied to technologies or the like for accommodating a treatment target, sterilizing the treatment target by using plasma, or treating a surface of the treatment target.

1. A packaging container comprising a housing portion capable of accommodating a treatment target,
wherein the housing portion comprises a permeable portion through which gas is permeable, and an electrical connection member electrically connectable to an electrode portion disposed externally, and
dielectric-barrier discharge is generated inside the housing portion through the permeable portion so that the treatment target accommodated inside the housing portion is plasma-treated.

2. The packaging container of claim 1, wherein the electrode portion comprises a first electrode, and a second electrode disposed to be spaced apart from the first electrode,
the electrical connection member is electrically connectable to the first electrode, and
an electric field is generated inside the housing portion through the permeable portion by the electrical connection member and the second electrode disposed externally.

3. The packaging container of claim 2, wherein the second electrode, the permeable portion, and the electrical connection member are aligned in a preset direction.

4. The packaging container of claim 2, wherein the treatment target comprises a conductive area,
the electrical connection member is electrically connected to the treatment target, and
the second electrode, the permeable portion, and the treatment target are aligned in a preset direction.

5. The packaging container of claim 1, wherein internal pressure of the housing portion is adjusted by the permeable portion, and the dielectric-barrier discharge is generated inside the housing portion by using the electrical connection member as a dielectric so that the treatment target housed therein is plasma-treated.

6. The packaging container of claim 5, wherein one side of the electrical connection member is electrically connected to the electrode portion disposed externally to adjust a shape or intensity of an electric field for the dielectric-barrier discharge.

7. The packaging container of claim 6, wherein the other side of the electrical connection member, which is opposite to the one side, is electrically connected to the treatment target.

8. The packaging container of claim 7, wherein the electrical connection member fixes the treatment target.

9. The packaging container of claim 7, wherein the electrical connection member has magnetism.

10. The packaging container of claim 6, comprising an embedded portion which covers an outer circumferential surface of the electrical connection member and is made of an insulating material.

11. The packaging container of claim 1, wherein at least one hole having a size of 10 μm or less is formed in the permeable portion.

12. The packaging container of claim 1, wherein the permeable portion has a recovery structure in which a gas flow path is temporarily formed by an external device and then closed.

13. The packaging container of claim 1, wherein the housing portion comprises a first housing body in which the treatment target is accommodated and a first permeable portion is formed, and a second housing body in which the first housing body is accommodated and a second permeable portion is formed, and further comprises a sealing member which seals a gas flow path toward the first permeable portion and the second permeable portion.

14. The packaging container of claim 1, further comprising a fixing member which has a fixing force counteracting an external force for taking out the treatment target from the packaging container and fixes the treatment target,
wherein the fixing force is released by an external force that separates the treatment target from the fixing member.

15. The packaging container of claim 14, wherein the fixing member has an open one side through which the fixing force is released.

16. The packaging container of claim 14, wherein the fixing member has an elastic restoring force for releasing the fixing force.

17. A plasma treatment apparatus comprising:
an accommodation portion in which a packaging container, in which a treatment target is accommodated and which has at least one hole, is accommodated; and
an electrode portion which is disposed on one surface of the accommodation portion facing the at least one hole, and generates an electric field inside the packaging container through the at least one hole.

18. The plasma treatment apparatus of claim 17, further comprising:
an airtightness forming portion which is in contact with the packaging container and forms a sealed area including an inside of the packaging container; and
a pressure adjustment portion which forms a low-pressure atmosphere inside the sealed area.

19. The plasma treatment apparatus of claim 18, wherein the pressure adjustment portion comprises:
a pressure adjustment hole formed opposite to the at least one hole of the packaging container; and
an exhaust portion which evacuates an inside of the sealed area through the pressure adjustment hole.

20. A plasma treatment method comprising:
accommodating a packaging container in an accommodation portion of a plasma treatment apparatus, wherein the packaging container has a permeable portion which is arranged to face an electrode portion provided in the plasma treatment apparatus and has at least one hole, and a treatment target is accommodated in the packing container; and
generating an electric field inside the accommodation portion,
wherein the electric field is generated inside the packaging container through the at least one hole.

21. The plasma treatment method of claim 20, wherein, in the generating of the electric field, the packaging container and the electrode portion are electrically connected to each other, and the electric field is generated inside the packaging container.

22. The plasma treatment method of claim 21, wherein the packaging container comprises an electrical connection member,
the treatment target includes a conductive area, and
in the generating of the electric field, the electrical connection member and the conductive area are electrically connected to each other to generate the electric field.

23. The plasma treatment method of claim 20, further comprising, before the accommodating of the packaging container in the accommodation portion, opening the at least one hole of the packaging container or deforming a size or shape of the at least one hole.

24. The plasma treatment method of claim 20, further comprising, before the accommodating of the packaging container in the accommodation portion, adjusting a position of the treatment target to approach the electrode portion or coupling the packaging container to a connection jig.

25. The plasma treatment method of claim 20, further comprising:
evacuating an inner space of the accommodation portion to form a low-pressure atmosphere inside the packaging container through the at least one hole; and
discharging the low-pressure atmosphere by using the electric field to plasma-treat the treatment target.

26. The plasma treatment method of claim 20, further comprising:
evacuating an inner space of the accommodation portion to form a low-pressure atmosphere;
discharging the low-pressure atmosphere by using the electric field; and
introducing the discharged low-pressure atmosphere into the packaging container through the at least one hole to plasma-treat the treatment target.
